(19) United States
(12) Patent Application Publication
(10) Pub. No.: US 2011/0285652 A1
(43) Pub. Date: Nov. 24, 2011

(54) BROADCAST RECEIVING DEVICE AND ELECTRONIC DEVICE

(75) Inventors: Akira IMAMURA, Hamura-shi (JP); Toshikatsu NAKAMURA, Akishima-shi (JP)

(73) Assignee: KABUSHIKI KAISHA TOSHIBA, Tokyo (JP)

(21) Appl. No.: 13/070,361

(22) Filed: Mar. 23, 2011

(30) Foreign Application Priority Data
May 21, 2010 (JP) 2010-117739

(51) Int. Cl. G06F 3/041

(52) U.S. Cl. 345/173

(57) ABSTRACT

According to one embodiment, an electronic device includes a first unit and a second unit rotatably coupled to each other by a hinge mechanism. The first unit is provided with two operation buttons arranged symmetrical with respect to the center line passing through the respective centers of the first and second units. The second unit includes a power button that is superposed on one of the two operation buttons when the first and second screens are superposed on each other. One of the two operation buttons is used to display a keyboard image which permits an input operation through a touch panel.

### CROSS-REFERENCE TO RELATED APPLICATIONS

This application is based upon and claims the benefit of priority from Japanese Patent Application No. 2010-117739, filed May 21, 2010; the entire contents of which are incorporated herein by reference.

### FIELD

Embodiments described herein relate generally to a broadcast receiving device and an electronic device, which have operation buttons on their displays.

### BACKGROUND

There are known broadcast receiving devices with operation buttons, such as power buttons, provided on the front surfaces of their displays, and electronic devices with touch panels used to perform various input operations.

By thus providing a user interface at the main unit side, the operability and accordingly, the convenience of the device can be enhanced, without employing an input device, such as a remote controller or a keyboard, separate from the main unit, such as a remote controller and a keyboard.

However, in, for example, an electronic device with a touch panel, in order to display a desired operation screen, it is necessary to switch some operation screens from one to another. In this case, a lot of time is required to finish one operation, which degrades processing efficiency.

There is a need for a broadcast receiving device or an electronic device having high operability and convenience.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a front view illustrating an example of a broadcast receiving device according to a first embodiment;

FIG. 2 is a sectional view taken along line II-II in FIG. 1;

FIG. 3 is a sectional view illustrating an elastic bush incorporated in the broadcast receiving device of FIG. 1;

FIG. 4 is a sectional view taken along line IV-IV in FIG. 1;

FIG. 5 is a sectional view taken along line V-V in FIG. 1;

FIG. 6 is a front view illustrating an example of a display screen of the broadcast receiving device of FIG. 1;

FIG. 7 is a view illustrating a left operation button provided on the broadcast receiving device of FIG. 1;

FIG. 8 is a view illustrating a right operation button provided on the broadcast receiving device of FIG. 1;

FIG. 9 is a perspective view illustrating an example of an electronic device according to a second embodiment;

FIG. 10 is a view illustrating a state in which the electronic is closed;

FIG. 11 is an exploded perspective view illustrating the electronic device of FIG. 9;

FIG. 12 is a perspective view of the rear side of a first main unit incorporated in the electronic device of FIG. 9, illustrating a state in which a battery pack is removed from the rear side;

FIG. 13 is a perspective view illustrating the reverse side of a touch panel unit incorporated in the first main unit, from which side operation mechanism support members are detached;

FIG. 14 is a perspective view illustrating a state in which the operation mechanism support members are attached to the structure of FIG. 13;

FIG. 15 is a sectional view taken along line XV-XV in FIG. 9;

FIG. 16 is a sectional view taken along line XVI-XVI in FIG. 9;

FIG. 17 is a perspective view illustrating each operation mechanism support member of the electronic device of FIG. 9 viewed from the front;

FIG. 18 is a perspective view illustrating a cover member for covering the operation mechanism of the electronic device of FIG. 9;

(a) of FIG. 19 shows the top of the cover member shown in FIG. 18, (b) of FIG. 19 shows a side of the cover member, and (c) of FIG. 19 shows the bottom of the cover member;

FIG. 20 is a view illustrating a left operation button provided on the first main unit of the electronic device of FIG. 9;

FIG. 21 is a view illustrating a right operation button provided on the first main unit of the electronic device of FIG. 9;

FIG. 22 is a perspective view illustrating a state in which the electronic device of FIG. 1 is used with one display panel thereof above the other, and one image is displayed on the two panels;

FIG. 23 is a perspective view illustrating a state in which a keyboard is displayed on the display panel of the first main unit shown in FIG. 22;

FIG. 24 is a perspective view illustrating a state in which a mouse pad is displayed on the display panel of the first main unit shown in FIG. 22;

FIG. 25 is a block diagram illustrating a control circuit for causing the keyboard to be displayed on the display panel of the first main unit as shown in FIG. 23;

FIG. 26 is a flowchart useful in explaining the operation of displaying the keyboard on the display panel of the electronic device of FIG. 9; and

FIG. 27 is a sectional view taken along line XXVII-XXVII in FIG. 9.

### DETAILED DESCRIPTION

Various embodiments will be described hereinafter with reference to the accompanying drawings.

In general, according to one embodiment, an electronic device 10 comprises a first main unit 11 and a second main unit 12 that are rotatably coupled by a hinge mechanism 13. Two push button mechanisms 30 are incorporated in the first main unit 11 and arranged symmetrical with respect to a center line C passing through the respective centers of the long sides of a display panel 24 incorporated in the first main unit 11. The second main unit 12 incorporates a power button 16 that is superposed on one of the push button mechanisms 30 when the display panel 24 is superposed on a display panel 15 incorporated in the second main unit 12. One of the push button mechanisms 30 is assigned as an operation button 30L for displaying an input-operation enabled keyboard on a touch panel 23a.

### First Embodiment

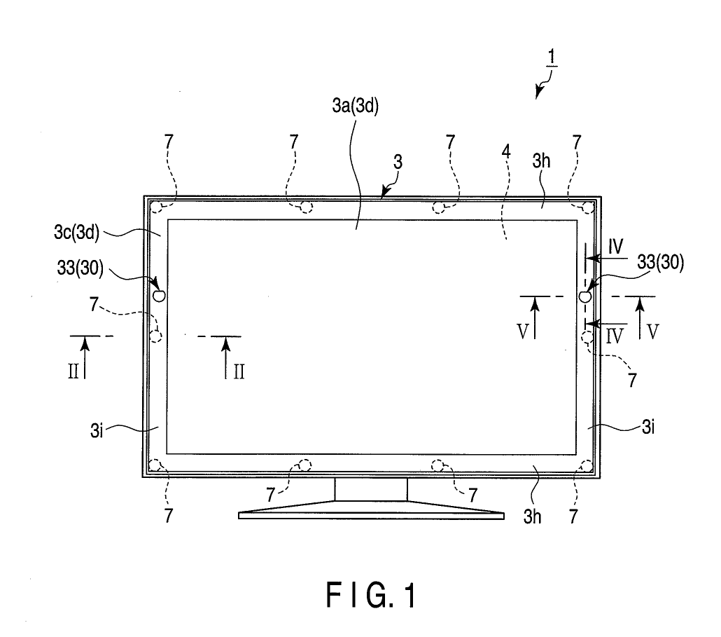

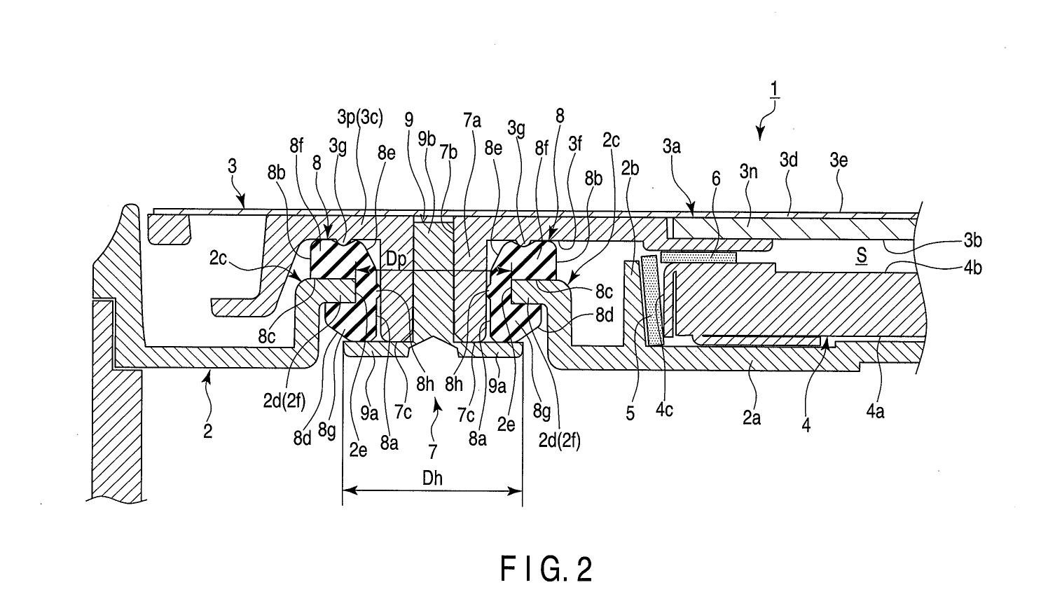

As shown in FIG. 1, a television receiver 1 (broadcast receiving device) according to a first embodiment has a rectangular shape when viewed from the front. The television receiver 1 comprises a housing 2, and a touch panel 3a swingably supported by the housing 2. As also shown in FIG. 2, a display panel 4, such as a liquid crystal display (LCD), is attached to the rear surface 3b (i.e., the lower surface in FIG. 2) of the touch panel 3a. The display panel 4 has its rear side 4a secured to the housing 2, using, for example, screws (not shown).

As shown in FIGS. 1 and 2, a rectangular frame 3c is provided around the touch panel 3a as a thin rectangular plate. The frame 3c is formed of a synthetic resin, a metal or the like. The touch panel 3a and the frame 3c are covered with a transparent cover 3d by double-sided tape, an adhesive, etc. The cover 3d is formed of, for example, a thin synthetic resin film or plate. The touch panel 3a and the frame 3c are integrated by the cover 3d. The peripheral portion 3n of the touch panel 3a is held between the frame 3c and the cover 3d. The peripheral portion of the cover 3d is painted in, for example, black so as not to expose the peripheral portion 3n of the touch panel 3a and the frame 3c to the outside. In the first embodiment, the touch panel 3a, frame 3c and cover 3d constitute a touch panel unit 3.

As shown in FIG. 2, the housing 2 comprises a rectangular bottom 2a on which the display panel 4 is placed, and at least one projection 2b (in this embodiment, a plurality of projections 2b) opposing each side surface 4c of the display panel 4. In the first embodiment, the projections 2b are arranged at intervals along the periphery (side surfaces 4c) of the display panel 4. The projections 2b can serve as positioning portions used when the display panel 4 is attached to the housing 2, and can serve as energy absorption portions when a lateral impact (i.e., an impact exerting in the right-left directions in FIG. 2) is exerted on the display panel 4. Further, elastic members 5 formed of sponge, elstomer or the like are interposed between the side surfaces 4c of the display panel 4 and the projections 2b. The elastic members 5 suppress the jounce of the display panel 4, and enhance the energy absorption performance.

The display panel 4 is flat and rectangular. The display panel 4 receives a video signal from a video signal processing circuit included in a control circuit, both of which are not shown and are formed of, for example, electronic components mounted on a printed board, thereby displaying a still and/or moving image corresponding to the video signal. The light corresponding to the image displayed on the front surface 4b of the display panel 4 is forwardly emitted through the transparent touch panel 3a. The control circuit of the television receiver 1 comprises, as well as the video signal processing circuit, a tuner, a High-Definition Multimedia Interface (HDMI), an audio video (AV) input terminal, a remote signal receiving section, a controller, a selector, an on-screen display interface, a storing unit (e.g., ROM, RAM, HDD, etc.) and a voice signal processing circuit. The television receiver 1 also contains an amplifier and a speaker for voice output, which are not shown.

The touch panel 3a includes two transparent conductive films (not shown). When a finger of a user, or a stylus presses the conductive films, a current flows at the pressed portion, whereby the pressed portion is detected. The signal indicating the pressed portion of the touch panel 3a is sent to the above-mentioned controller, where processing based on the signal is executed.

The television receiver 1 of the first embodiment also comprises a vibration mechanism (not shown). The vibration mechanism includes a motor, and an eccentric weight to be rotated by the motor, and is attached to the rear surface 3f of the rectangular plate-like wall 3p of the frame 3c. The controller of the television receiver 1 operates the vibration mechanism to vibrate, for example, the touch panel unit 3 when the touch panel 3a is pressed. The user feels the vibration through the panel-pressed finger or stylus to thereby recognize that the pressing operation on the touch panel 3a has been accepted.

Between the front surface 4b of the display panel 4 and the rear surface of 3f of the frame 3c, a beltlike seal member 6 is provided along the peripheral portion of the front surface 4b of the display panel 4. The seal member 6 is formed of a flexible material, such as sponge, and suppresses entrance of, for example, foreign particles from the outside into the space S between the front surface 4b of the display panel 4 and the rear surface 3b of the touch panel 3a. The repulsive force of the seal member 6 is set to a low value so as to minimize its adverse influence on the swing or vibration of the touch panel unit 3. Namely, the seal member 6 little assists the support of the touch panel unit 3 by the housing 2.

The touch panel unit 3 as the front panel is swingably supported by the housing 2 as a support base via a plurality of swing support mechanisms (coupling mechanisms) 7, as is shown in FIGS. 1 and 2. The touch panel unit 3 can swing relative to the housing 2 in a direction of depth (i.e., in a direction perpendicular to the front surface 3e of the panel 3) and in a lateral direction (i.e., in a direction perpendicular to the depth direction). The swing support mechanisms 7 are arranged along the periphery of the touch panel unit 3. Preferably, the swing support mechanisms 7 are arranged symmetrical with respect to the vertical center line parallel to the two short sides of the panel 3, or the horizontal center line parallel to the two long sides of the panel 3, and are arranged in four or more positions. The swing support mechanisms 7 support the frame 3c of the touch panel unit 3.

In the first embodiment, each swing support mechanism 7 comprises a support bracket 2c incorporated in the housing 2, an elastic bush 8 attached to the support bracket 2c, a coupling portion 7a inserted through a through hole 8a formed in the elastic bush 8, and a screw 9 screwed into the coupling portion 7a, as is shown in FIG. 2. In this embodiment, the support bracket 2c corresponds to a base portion, the frame 3c corresponds to a brim member, and the front wall 3p of the frame 3c corresponds to a to-be-supported portion.

The support bracket 2c is formed as a cylindrical boss projecting from the bottom 2a of the housing 2 to the to-be-supported front wall 3p of the frame 3c. A circular through hole 2e is formed in the central portion of the top wall 2d of the support bracket 2c, thereby providing an inwardly extending flange 2f.

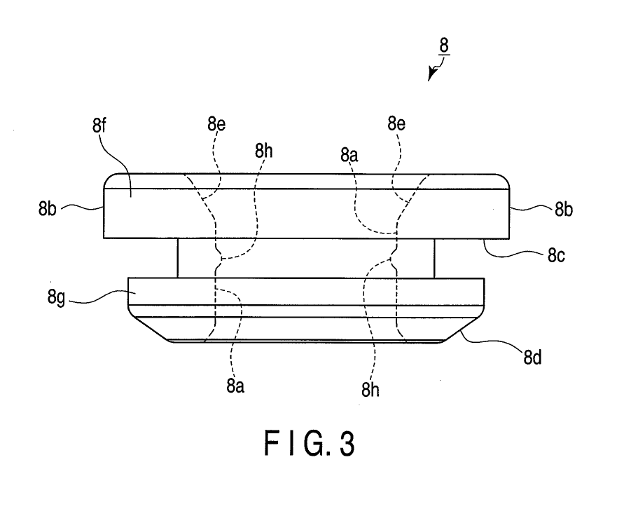

The elastic bush 8 is an elastic cylindrical member formed of an elastomer (e.g., synthetic rubber) more flexible than the housing 2 and the frame 3c (coupling portion 7a). As shown in FIGS. 2 and 3, an outer peripheral groove 8c is formed in the axially (i.e., vertically) central portion of the outer peripheral surface 8b of the bush 8. By engaging the outer peripheral groove 8c with the flange 2f of the support bracket 2c, the elastic bush 8 is attached to the support bracket 2c.

Since the elastic bush 8 is elastically deformable, the worker can relatively easily insert the bush 8 into the through hole 2e from the front to attach the same to the support bracket 2c. The elastic bush 8 is formed asymmetrical with respect to its axis. This reduces the possibility of the bush being attached to the support bracket 2c in a wrong manner. Further, as shown in FIGS. 2 and 3, the elastic bush 8 has an outwardly narrowed slope 8d at the periphery of an end thereof corresponding to the position of the head 9a of the screw 9. The slope 8d serves to guide the coupling portion 7a to the through hole 8a when the coupling portion 7a is inserted into the through hole 8a. The slope 8d suppresses degradation of the assemblage attitude of the elastic bush 8 that may occur when the coupling portion 7a is inserted into the through hole 8a.

The coupling portion 7a is formed as a cylindrical boss rearward projecting from the frame 3c. As shown in FIG. 2, in the assembled state, the coupling portion 7a is inserted through the through hole 2e of the support bracket 2c and projects to the rear side of the support bracket 2c. The coupling portion 7a has a female screw hole 7b as a female portion opening rearward. In the first embodiment, the female screw hole 7b is formed as a through hole extending through the front wall 3p of the frame 3c, but may be formed as a hole with a bottom that opens only rearward.

The screw 9 comprises a head 9a, and a male portion 9b engaged with the female screw hole 7b. The screw 9 is screwed until the head 9a is brought into contact with an end face 7c of the coupling portion 7a.

Each swing support mechanism 7 as shown in FIG. 2 is realized by attaching the elastic bush 8 to the support bracket 2c from the front, making the housing 2 close to the touch panel unit 3 from the front to insert the coupling portion 7a into the through hole 8a of the elastic bush 8, and fastening, from behind, the screw 9 into the female screw hole 7b of the coupling portion 7a as the boss. Since thus, the elastic bush 8 is fitted into the support bracket 2c, the worker can more easily and smoothly perform the assemblage than in the case where an elastic member is adhered or screwed.

Further, in the first embodiment, the coupling portion 7a is inserted through the through hole 8a of the elastic bush 8 along the depth. Accordingly, simply by superposing the display panel 4 and the touch panel unit 3 on each other, the state in which the coupling portion 7a is inserted through the through hole 8a can be obtained, which makes the assemblage more easily and smoothly.

Also in the first embodiment, where each swing support mechanism 7 is assembled as shown in FIG. 2, the front expanded portion 8f of the corresponding elastic bush 8 is interposed between the corresponding support bracket 2c as part of the housing 2, and the frame 3c of the touch panel unit 3 provided in front of the bracket, and the rear expanded portion 8g of the corresponding elastic bush 8 is interposed between the corresponding support bracket 2c and the screw 9 provided behind the bracket. Namely, the repulsive force of the elastic bush 8 can more easily be exerted to cope with both a rearward force (such as external force or inertia force) exerted on the touch panel unit 3 from the front, and a forward force exerted on the same from behind. This enables variation in the forward swing (vibration) of the touch panel unit 3 and in the rearward swing (vibration) of the same to be easily controlled. Further, since the elastic bush 8 surrounds the coupling portion 7a, it can suppress variation in the lateral swing property (vibration property) of the touch panel unit 3. To realize easy swing (vibration), it is preferable to set, to a relatively low value, the initial load due to the structure in which the front and rear expanded portions 8f and 8g are held by the above-mentioned members. The initial load means a load assumed when no external force is exerted.

Further, in the first embodiment, each support bracket unit 2c is formed as a boss forwardly projecting from the bottom 2a of the housing 2 (i.e., toward the front wall 3p of the frame 3c). This structure suppresses rearward projection of the swing support mechanisms 7 from the bottom 2a, whereby the swing support mechanisms 7 can be easily received in the housing 2. Further, since the elastic bushes 8 as the bases of the frame 3c are kept in contact with the front wall 3p, it is not necessary to provide the frame 3c with dedicated contact portions with which the bushes 8 are kept in contact, whereby the swing support mechanisms 7 can be made more simple in structure.

In the swing support mechanisms 7 constructed as the above, the touch panel unit 3 is harder to vibrate as the contact areas between the touch panel unit 3 and the elastic bushes 8 are greater. In view of this, the first embodiment includes a structure for reducing the contact areas between the touch panel unit 3 and the elastic bushes 8 when they are assembled. As an example, an annular projection 8h for reducing the contact areas of the inner surface of the through hole 8a and the outer surface of the coupling portion 7a is provided on the inner surface of the through hole 8a in each elastic bush 8. As another example, a plurality of projections 3g arranged circular are provided on those portions of the rear surface 3f of the frame 3c that oppose the elastic bushes 8. The projections 3g reduce the contact areas of the rear surface 3f of the frame 3c and the front surfaces of the elastic bushes 8. Of course, the invention is not limited to these examples. Alternatively, the coupling portions 7a have projections, or the front surfaces of the elastic bushes 8 have projections. These projections may be formed as annular projections, or may each formed of a plurality of projections arranged circular.

Also, in the first embodiment, the outer diameter Dh of each head 9a is greater than the inner diameter Dp of the through hole 2e of the corresponding support bracket 2c. Accordingly, even if the elastic bushes 8a cannot be attached, or are removed from the support brackets 2c because of, for example, degradation over time, the screws 9 are prevented from coming off from the through holes 2e of the support brackets 2c, thereby preventing the touch panel unit 3 from being unintentionally detached from the housing 2. Washers (not shown) may be interposed between the heads 9a and the elastic bushes 8. The washers suppress twisting of the elastic bushes 8 when the screws 9 are screwed. In this case, it is sufficient if the washers are formed to have a greater outer diameter than the inner diameter Dp of the through holes 2e.

In the first embodiment, the push button mechanisms 30 are exposed on the front surface of the touch panel unit 3 swingably supported by the housing 2. Each push button mechanism 30 is covered with a cover member 33 as a member movable relative to the frame 3c, and accepts an pushing operation from the front of the television receiver 1.

In the first embodiment, the push button mechanisms 30 are provided on the respective vertical portions 3i of the frame 3c as shown in FIG. 1. Further, in the embodiment, two push button mechanisms 30 are provided between respective pairs of frame portions supported by the swing support mechanisms 7.

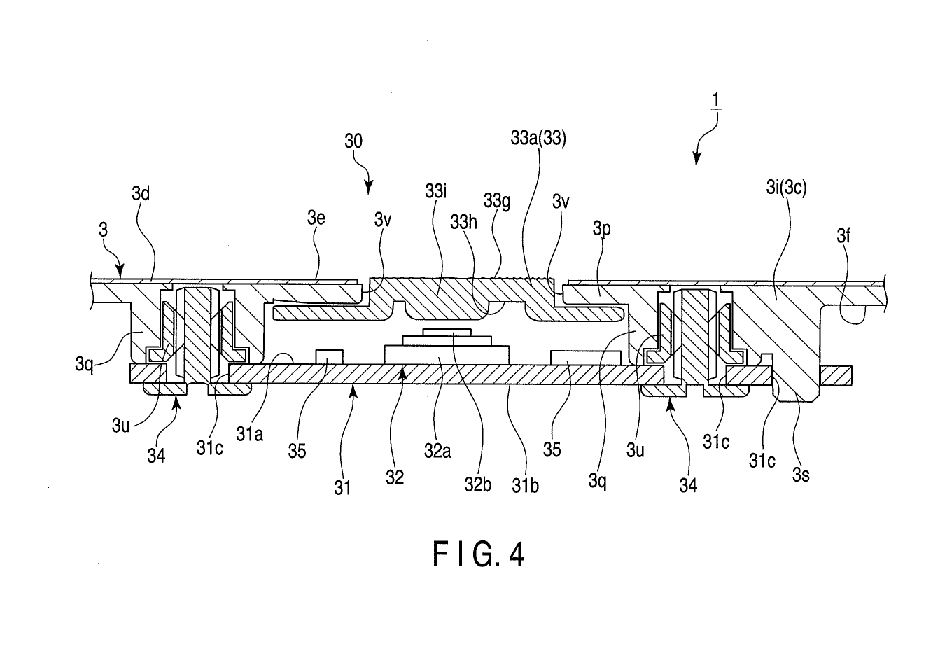

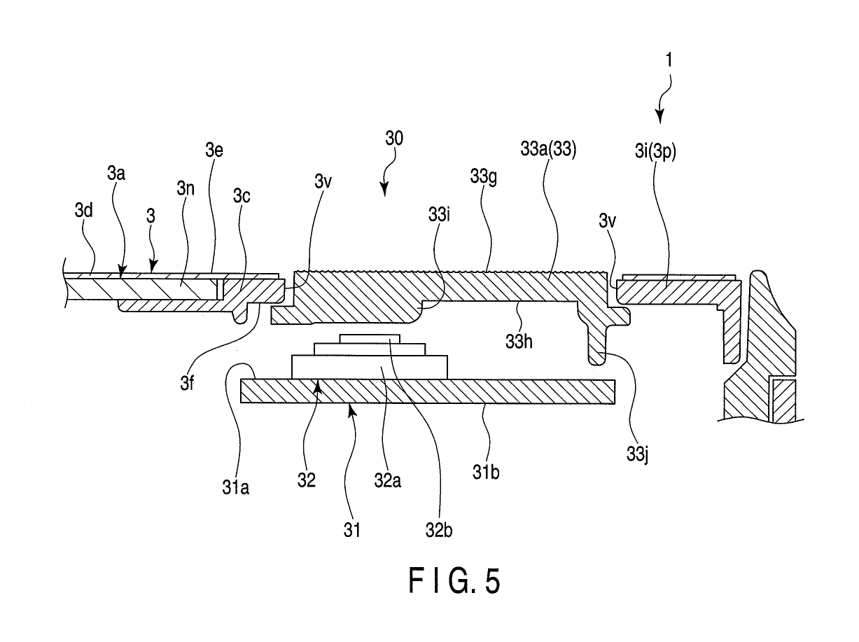

As shown in FIGS. 4 and 5, each push button mechanism 30 comprises a board 31 as an operation mechanism support member, a push button switch 32 as a operation mechanism main unit attached to the board 31, and a cover member 33 that covers the push button switch 32.

The board 31 is located behind and parallel to the front wall 3p of the frame 3c with a gap therebetween, and has a front surface 31a and a rear surface 31b.

As shown in FIG. 4, rearward projecting bosses 3q serving as support member fixing portions are provided at the front wall 3p of the frame 3c. The bosses 3q are arranged at intervals along the peripheral portion 3n (see FIG. 5) of the touch panel 3a. In the first embodiment, two bosses 3q are provided for each push button mechanism 30. Cylindrical female screw members 3u are fitted in the bosses 3q by, for example, insert molding. Screw 34 inserted through the corresponding through holes 31c of the board 31 are screwed into the female screw members 3u, thereby securing the board 31 to the bosses 3q. Rearward projections 3s are incorporated in the front wall 3p. The board 31 has the aforementioned through holes 31c through which the projections 3s are inserted. The projections and the through holes 31c through which the projections 3s are inserted serve as positioning means for the board 31. Each projection 3s and the boss 3q adjacent thereto is integrated by, for example, a rib.

In the first embodiment, the board 31 is formed as a printed circuit board. The push buttons 32, components 35, etc., are mounted, by, for example, soldering, on the front surface 31a of the board 31 opposing the rear surface 3f of the front wall 3p. The push buttons 32 are connected to a control circuit (not shown) including, for example, a CPU, via, for example, patterned wiring provided on the board 31, and a connector (not shown) included in components 35 mounted on the board 31, or a harness (not shown) connected to the connector.

Each push button switch 32 includes a main body 32a, and a movable portion 32b set retractable/projectable with respect to the main unit 32a. The movable portion 32b is projectable and retractable back and forth with respect to the main unit 32a. Each push button switch 32 contains a contact pair including a stationary contact and a movable contact (both of which are not shown). When the pair of contacts are connected, the circuit including the contacts is closed.

Each cover member 33 covers the front side of the corresponding push button switch 32 with a gap therebetween. Each cover member 33 is formed of an elastic material, such as elastomer or a synthetic resin, and is secured to the rear surface 3f of the front wall 3p by, for example, welding or adhesion. Through holes 3v are formed in the front wall 3p. The operation portion 33a of each cover member 33 is inserted through the corresponding through hole 3v and exposed to the front surface 3d side of the touch panel unit 3. In the first embodiment, the top surface 33g of the operation portion 33a is substantially level with the front surface 3e of the touch panel unit 3. When each cover member 33 is pressed by, for example, a finger of a user, it elastically warps rearward (downward in FIGS. 4 and 5), whereby its operation portion 33a is depressed from the front surface 3e. When the pressure is released, each cover member 33 is returned forward to its initial state.

As shown in FIG. 5, the reverse surface 33h of the operation portion 33a has a projection 33i opposing the movable portion 32b of the push button switch 32, and a projection 33j opposing the front surface 31a of the board 31 away from the movable portion 32b. When the cover member 33 is pressed, the projection 33i presses down the movable portion 32b. Further, when the portion of each operation portion 33a away from the push button switch 32 (e.g., the right end of the operation portion 33a shown in FIG. 5) is pressed by, for example, a finger of the user, the projection 33j serves as a support that contacts the front surface 31a of the board 31. If there are no projections 33j, the operation portion 33a is inclined more rearward as it is remoter from the push button switch 32, with the result that the movable portion 32b may not reliably be pressed. The projection 3j employed in the first embodiment suppresses inclination of the operation portion 33a, and hence enables the operation portion 33a to reliably press the movable portion 32b. Thus, in the first embodiment, the projection 33j serves as an inclination suppressing portion. This structure is advantageous when the operation portion 33a of the cover member 33 is large relative to the push button switch 32. Namely, the projection 33j enables the push button switch 32 to be made smaller, and the operation portion 33a to be made larger. The inclination suppressing portion may be provided as a projection (such as a stud) on the board 31 side.

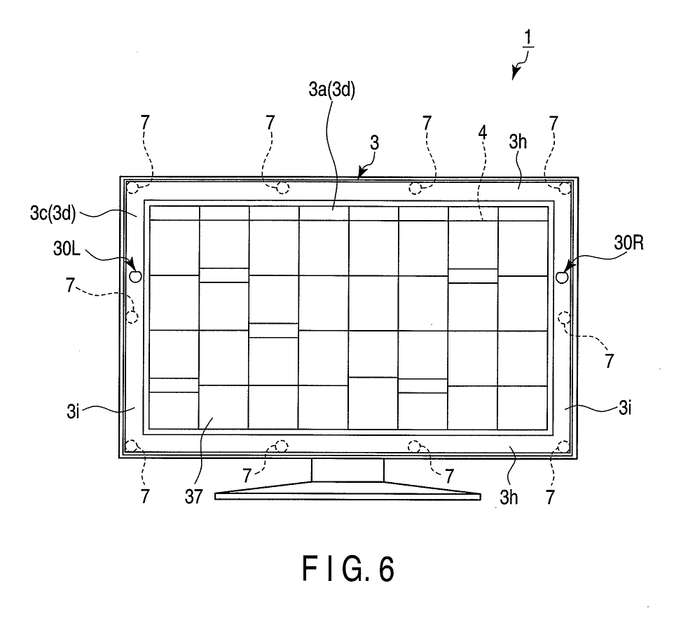

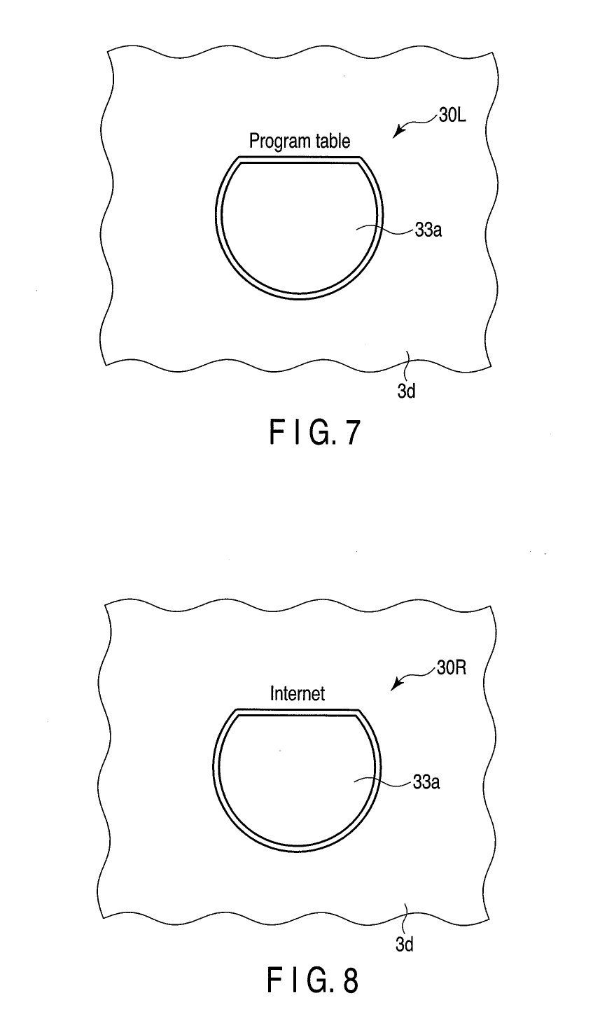

In the first embodiment, the left-hand push button mechanism 30 in FIG. 1 is assigned as an operation button 30L (shown in FIG. 7) for displaying, for example, the screen shown in FIG. 6. The screen of FIG. 6 shows, for example, a TV program table. Further, in the first embodiment, the right-hand push button mechanism 30 in FIG. 1 is assigned as an operation button 30R (shown in FIG. 8) for connecting the receiver 1 to the Internet.

For instance, as shown in FIG. 7, the operation portion 33a of the operation button 30L exposed at the front surface and used to display a TV program table is formed in a shape obtained by cutting an upper portion of a circular member. Characters, such as “TV Program Table,” for enabling the user to recognize the type of the operation button 30L are drawn near the cutout portion. These letters are, for example, outline white characters on a peripheral portion of the cover 3d painted in black.

Since the characters are drawn adjacent to the operation button 30L, the user can easily recognize for what the operation button 30L is used, which enhances the operability and convenience of the device. In the screen example of FIG. 6, by touching item 37 corresponding to a TV program, viewing or recording of the program can be designated.

In this case, since the operation button 30L for displaying the “TV Program Table” is positioned on the left side of the user when they view the TV receiver 1, they can touch a desired item 37 in the TV program table by the right hand immediately after they push the operation button 30L by the left hand. In light of the fact that most users are right-handed, the left-hand location of the operation button 30L is advantageous for realizing high operability.

Similarly, as is shown in FIG. 8, the operation portion 33a of the right-hand operation button 30R exposed at the front surface and used to access the Internet is also formed in a shape obtained by cutting an upper portion of a circular member. Characters “Internet” are drawn near the cutout portion.

As described above, in the first embodiment, the push button mechanisms 30 as operation mechanisms for receiving pressing operations from the front are provided on the frame 3c of the touch panel unit 3. This enables the push button mechanisms 30 to be more reliably pushed than in the case where the push button mechanisms are incorporated in the housing.

In particular, when as in the first embodiment, the touch panel unit 3 is vibrated by a vibration mechanism, integration of the push button mechanisms 30 with the touch panel unit 3 is advantageous in suppressing the occurrence of vibration or noise.

Further, in the first embodiment, the push button mechanisms 30 are each arranged between the swing support mechanisms 7. Accordingly, inclination of the touch panel unit 3 due to the pressing operation of the push button mechanisms 30 can be suppressed, whereby the push button mechanisms 30 can be more reliably pressed.

Furthermore, in the first embodiment, the push button mechanisms 30 comprise the board 31 provided behind the front wall 3p of the frame 3c with a gap therebetween, the push button switches 32 provided on the board 31 behind the front wall 3p, and the cover members 33 covering the respective push button switches 32 and exposed through the through holes 3v to the front side of the frame 3c. By virtue of this structure, the push button mechanisms 30 can be relatively easily mounted using the frame 3c of the touch panel unit 3.

Also in the first embodiment, the swing support mechanisms 7 each comprise the elastic bush 8 having the through hole 8a and having its outer periphery fitted in either the housing 2 or the touch panel unit 3 (in the embodiment, in the housing 2), and the screw 9 coupled to either the touch panel unit 3 or the housing 2 (in the embodiment, to the touch panel unit 3) for supporting the elastic bush 8 along with the touch panel unit 3. Since thus, the elastic bush 8 can be attached by fitting the same in either the housing 2 or the touch panel unit 3 (in the embodiment, in the housing 2), the assembler can more easily and smoothly attach the elastic bush than in the case of attaching the same by screwing or using an adhesive. Further, since the elastic bush 8 is arranged around the coupling portion 7a, variations in the swing characteristic (vibration characteristic) of the touch panel unit 3 in all directions perpendicular to the axis of the through hole 8a can be suppressed. Furthermore, since the elastic bush 8 fitted in either the housing 2 or the touch panel unit 3 (in the embodiment, in the housing 2) is held between either the touch panel unit 3 or the housing 2 (in the embodiment, the touch panel unit 3) and the screw 9 coupled to the touch panel unit 3, the repulsive force of the elastic bush 8 can be equally exerted in opposite axial directions, thereby suppressing variations in the swing characteristic (vibration characteristic) that occur in the opposite axial directions.

In addition, in the first embodiment, the elastic bush 8 of each swing support mechanism (coupling mechanism) 7 also serves as a suppressing portion for suppressing the swing of the tough panel unit 3 over the front surface (i.e., an XY plane) and in the directions other than the XY plane, i.e., in the directions intersecting the XY plane, and at least in the Z-direction (front-back direction). Namely, as shown in FIG. 2, the elastic bush 8 is provided around the flange 2f as an example part formed integral with the housing 2, and each part (such as the front wall 3p, the coupling portion 7a and the head 9a) formed integral with the touch panel unit 3 is provided to cover the periphery of the elastic bush 8. Accordingly, the elastic bush 8 is always held between the housing 2 and the touch panel unit 3 irrespective of any displacement of the touch panel unit 3. Thus, in the first embodiment, the elastic bush 8 as a suppression portion can suppress excessive displacement of the touch panel 3 or keep the displacement within a preset range.

In the first embodiment, since the mechanical operation buttons 30L and 30R are provided on the respective vertical portions 3i of the frame 3c, another user interface can be provided on the main unit side of the TV receiver 1 in addition to the separate remote controller, thereby enhancing the operability and convenience of the receiver 1. For instance, by pressing the operation button 30L assigned as a left-hand TV program display button, a program table at the current time can be quickly displayed. At this time, if the user touches the column of a TV program on the program table, they can instantly program viewing or recording of the TV program.

### Second Embodiment

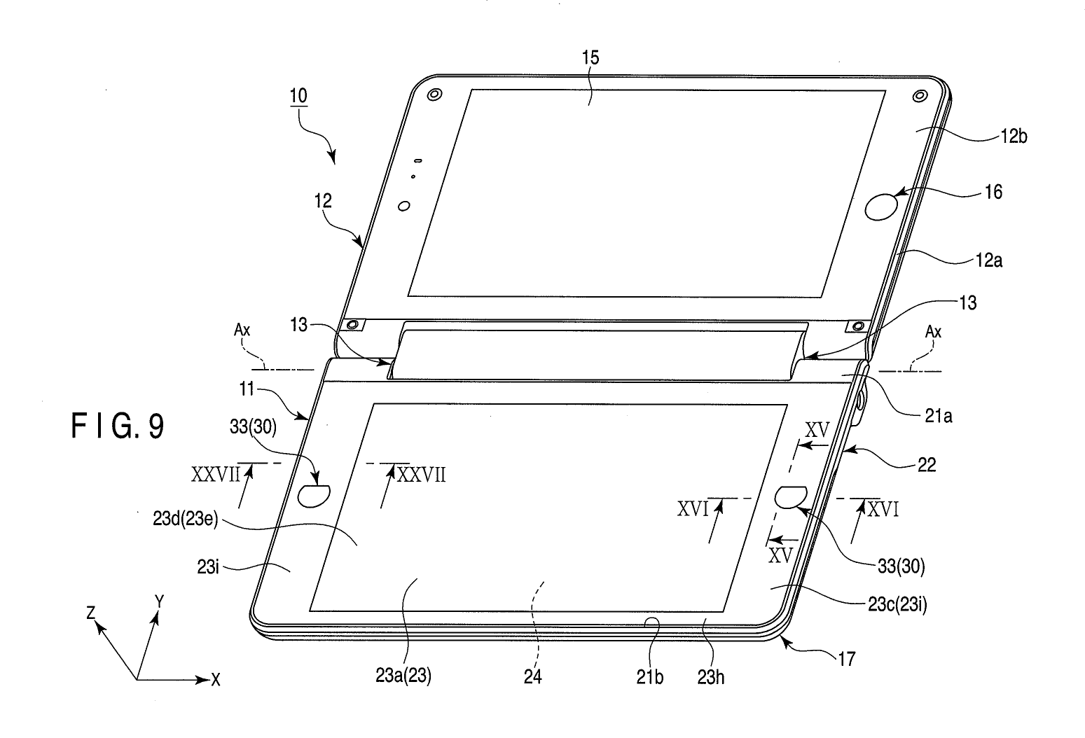

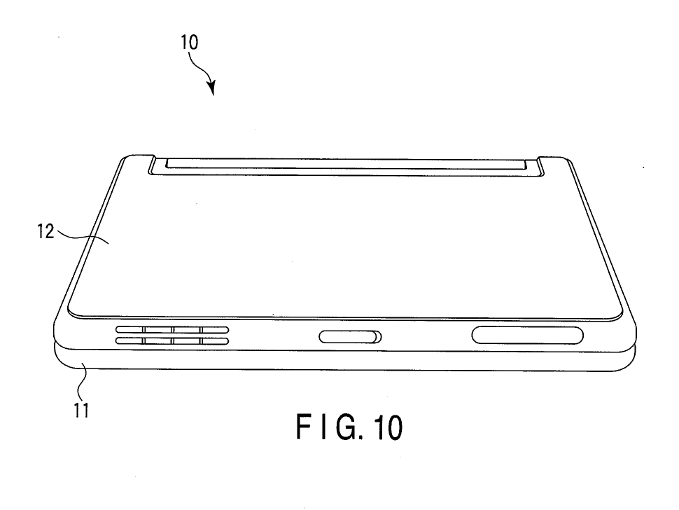

An electronic device 10 according to a second embodiment is formed as a so-called note PC, and comprises a first flat rectangular main unit 11, and a second flat rectangular main unit 12. The first and second main units 11 and 12 are coupled by a hinge mechanism 13 so that they can relatively rotate between the developed state shown in FIG. 9, obtained by a rotation about an axis Ax, and the folded state shown in FIG. 10. In the second embodiment, for facilitating the description, X-, Y- and Z-axes are defined. The X- and Y-axes are substantially included in the plane of the surface of the first main unit 11. The X-axis is parallel to the width of the first main unit 11. The Y-axis is parallel to the depth of the first main unit 11. The Z-axis is perpendicular to the surface of the first main unit 11. The X-, Y- and Z-axes are perpendicular to each other. The electronic device 10 has, for example, a tuner (not shown) and functions as a broadcast receiver.

As shown in FIG. 9, the first main unit 11 comprises a display panel 24, such as an LCD, provided with a touch panel 23a and a pair of push button mechanisms 30, which are exposed to the surface 21a of a housing 22. The second main unit 12 comprises a display panel 15, such as an LCD, provided with a touch panel 15a, a power button 16, a camera lens 19, etc., which are exposed to the surface 12b of a housing 12a. In the developed state shown in FIG. 9, the display panel 15, the display panel 24 with the touch panel 23a, cover members 33 for covering the button mechanisms 30, the power button 16, etc., are exposed, which permits a user to use them. In the folded state shown in FIG. 10, the surfaces 21a and 12b are opposed to each other with a slight clearance therebetween, whereby the display panel 15, the display panel 24, the cover members 33, the power button 16, etc., are hidden by the housings 22 and 12a. Although in the second embodiment, only the first main unit 11 has the touch panels 23a, the second main unit 12 may have a touch panel 23. In the second embodiment, the touch panel 23a corresponds to a front panel, and the housing 22 corresponds to a support base.

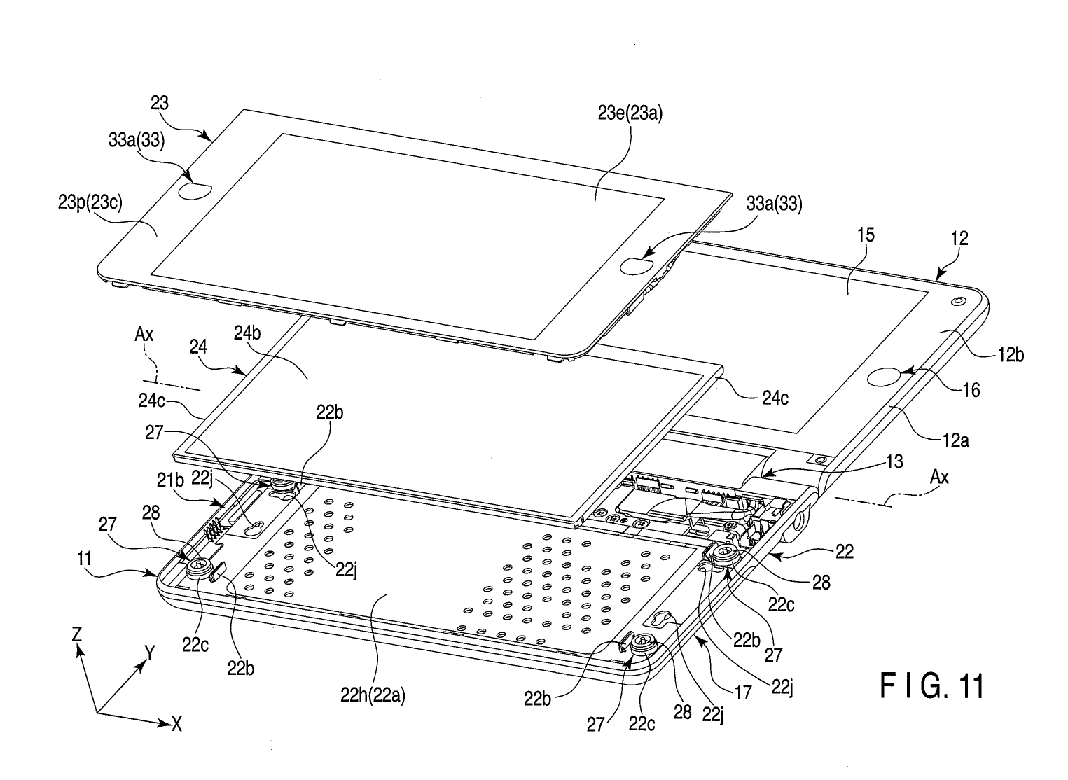

As shown in FIG. 11, in the second embodiment, the display panel 24 is provided on the bottom 22a of the housing 22 of the first main unit 11, and the touch panel unit 23 is provided on the display panel 24. In the second embodiment, the front and back sides of the display panel 24 are positioned along the Z-axis. Namely, the front and back sides of the display panel 24 are positioned vertically in FIGS. 9 and 11. In the embodiment, the touch panel unit 23 corresponds to a panel unit.

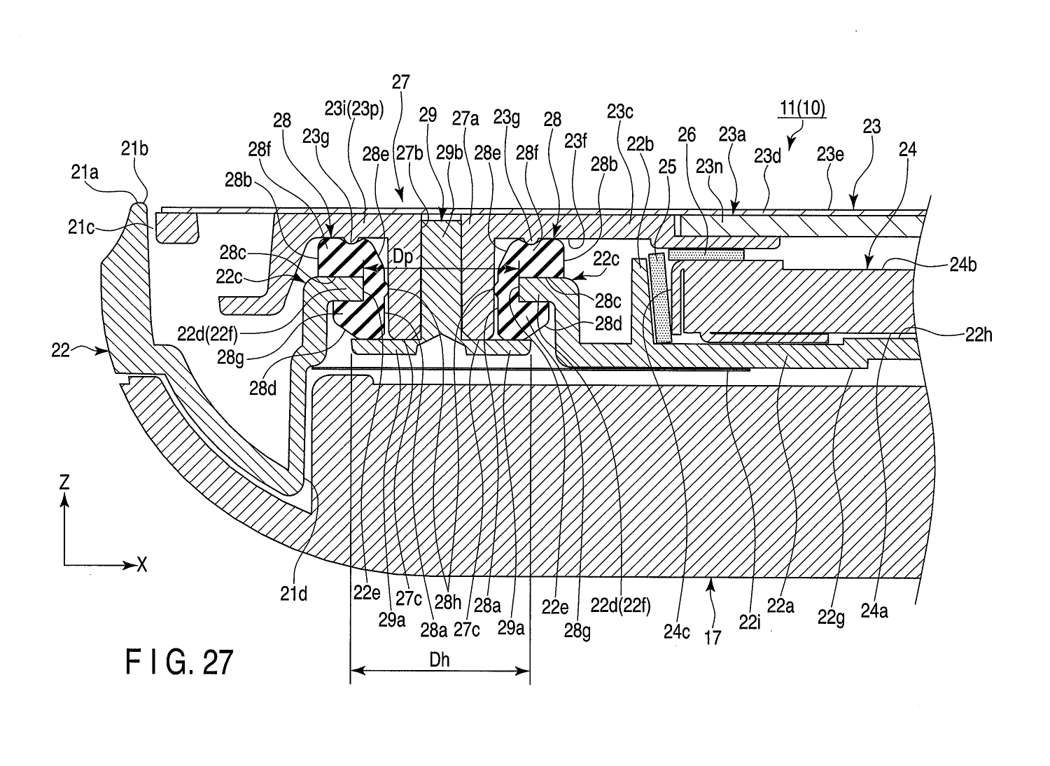

As shown in FIGS. 9 and 11, the housing 22 has an opening 21b upwardly opening and covered with the touch panel unit 23. The housing 22 has no upper wall except for the peripheral portion thereof close to the second main unit 12. Thus, the upper surface of the first main unit 11 is substantially formed of the upper surface 23e of the touch panel unit 23. A substantially constant clearance 21c (see FIG. 27) is defined between the touch panel 23 and the edge providing the opening 21b along the entire periphery of the touch panel 23.

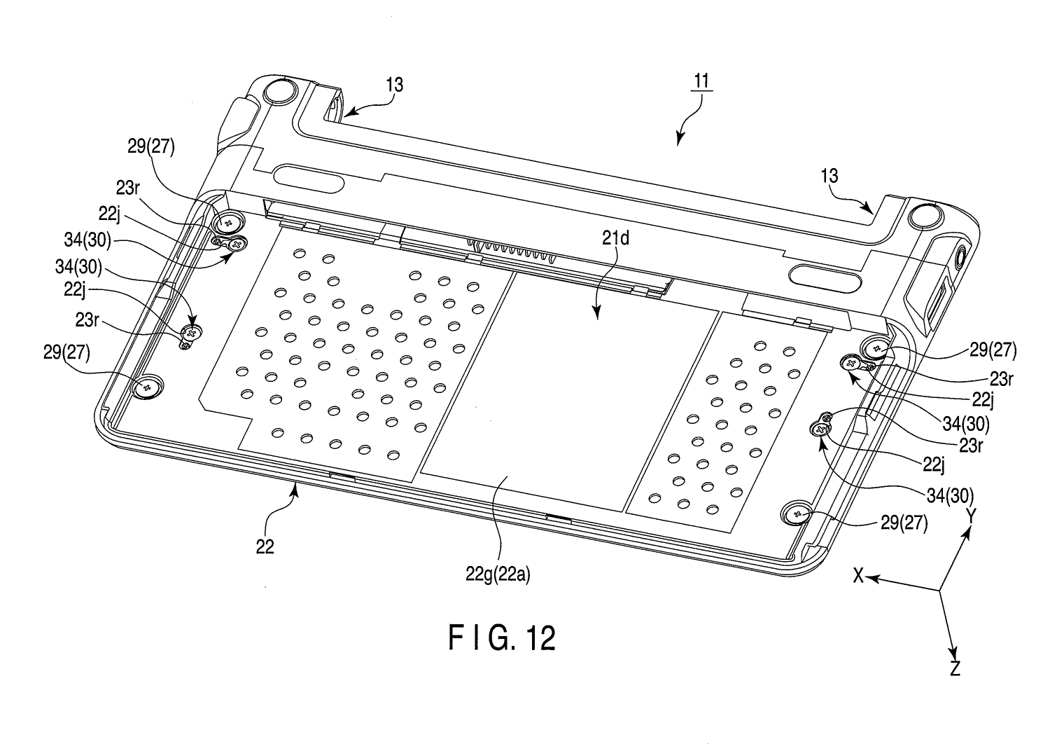

Further, as shown in FIG. 12, the lower wall of the housing 22 of the first main unit 11 has a recess 21d formed therein for receiving a flat rectangular battery pack 17 (see FIGS. 9, 11, 15, 27, etc.). More specifically, the recess 21d is provided at the front side of the first main unit 11 away from the hinge mechanism 13. The bottom of the recess 21d is the rear surface 22g of the bottom wall 22a. Namely, in the second embodiment, the bottom wall 22a of the housing 22 serves as a partition between the internal space of the housing 22 for receiving the display panel 24 and the touch panel 23, and the recess 21d for receiving the battery pack 17. The lower surface 24a of the display panel 24 is fixed to the bottom wall 22a by means of, for example, screws (not shown), as is shown in FIG. 27.

As shown in FIG. 11, the display panel 24 is placed on the upper surface 22h of the bottom wall 22a. Further, as is shown in FIG. 11, the portion (see FIG. 12) of the lower surface 22g of the bottom wall 22a, on which the battery pack 17 is placed, projects in front of the hinge mechanism 13. A plurality of (four in this embodiment) rectangular ribs 22b are provided on the projected portion of the bottom wall 22a. The ribs 22b upwardly project from the bottom wall 22a and oppose the short side surfaces 24c of the display panel 24. In the second embodiment, the ribs 22b serve as positioning members used when attaching the display panel 24 to the housing 22, and also serve as energy absorbing members for absorbing the energy that occurs when lateral impact is exerted on the display panel 24. In the second embodiment, two ribs 22b oppose one short side surface 24c, and hence four ribs 22b in total are provided on the bottom wall 22a.

The display panel 24 is placed on the upper surface 22h of the bottom wall 22a as shown in FIG. 11. Further, as shown in FIG. 11, cylindrical support brackets 22c with bottoms, which provide swing support mechanisms 27, project on the portion of the upper surface 22h of the bottom wall 22a corresponding to the position of the battery pack 17. A plurality of (four in this embodiment) support brackets 22c are provided outside the respective ribs 22b along the width of the housing 22. Elastic bushes 28 are attached to the respective support brackets 22c.

As shown in FIG. 11, the display panel 24 is formed flat and rectangular. The display panel 24 receives display signals from a control circuit formed of, for example, an electronic component (not shown) mounted on a printed circuit board (not shown), and displays still and moving images. In the second embodiment, light corresponding to video data displayed on the upper surface 24b of the display panel 24 serving as a display screen is emitted to the outside through the transparent touch panel 23a. The control circuit of the electronic device 10 comprises a controller, a memory (such as a read only memory (ROM), a random access memory (RAM) and a hard disk drive (HDD)), an interface circuit, various controllers, etc. The electronic device 10 also contains, for example, a loud speaker (not shown) for outputting voice signals.

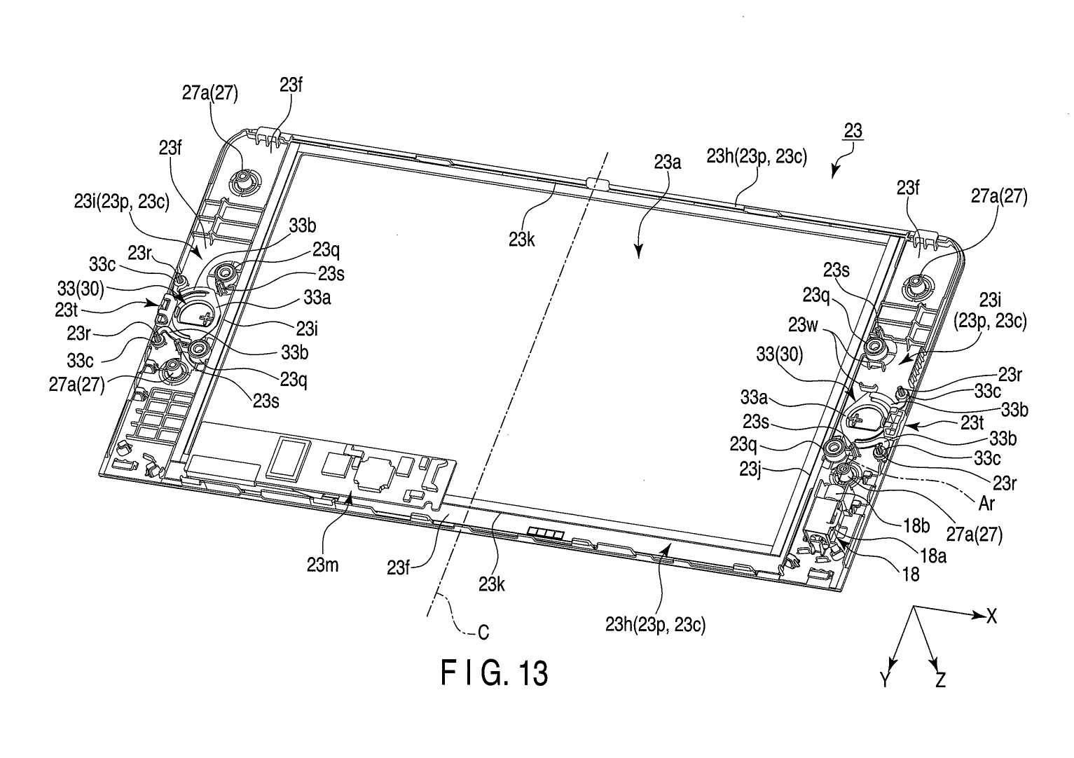

As shown in, for example, FIGS. 11 and 13, the touch panel unit 23 comprises the thin rectangular plate-like touch panel 23a, and a rectangular frame 23c surrounding the touch panel 23a. The frame 23c is formed of a synthetic resin or metal material. As shown in FIG. 27, the touch panel 23a and the frame 23c are adhered to a transparent cover 23d formed of a thin film or plate-like member of a synthetic resin, by means of a double-sided tape (not shown) or an adhesive. By the cover 23d, the touch panel 23a and the frame 23c are formed integral as one body. The periphery 23n of the touch panel 23a is held between the frame 23c and the cover 23d. The periphery of the cover 23d is painted, for example, black, to prevent the periphery 23n of the touch panel 23a and the frame 23c from being seen through the upper surface 23e of the touch panel unit 23. Further, as shown in FIG. 27, the second embodiment also incorporates an elastic member 25 having the same function as the elastic member 5 of the first embodiment, and a seal member 26 having the same function as the seal member 6 of the first embodiment.

As shown in FIG. 11, the frame 23c has a wall 23p that is in the shape of a rectangular plate-like frame. Further, as shown in FIG. 13, the wall 23p comprises long-side portions 23h extending along the X-axis, and short-side portions 23i extending along the Y-axis. In the second embodiment, coupling portions 27a included in the swing support mechanisms 27 are provided on the lower surfaces 23f of the short-side portions 23i that are wider than the long-side portions 23h. More specifically, two coupling portions 27a are provided on each of the two short-side portions 23i, namely, four coupling portions 27a are provided in total. Thus, the touch panel unit 23 is supported by the four swing support mechanisms 27.

Further, in the second embodiment, a vibration mechanism 18 is provided on the lower surface 23f of one of the short-side portions 23i (i.e., the right short-side portion 23i in FIG. 13). Another vibration mechanism 18 is incorporated in the second main unit 12, although it is not shown. In the second embodiment, the vibration mechanism 18 comprises a motor 18a, and an eccentric weight 18b to be rotated by the motor 18a. By rotating the eccentric weight 18b by the motor 18a, the center of gravity of the vibration mechanism 18 is vibrated (rotated) to thereby vibrate the frame 23c and accordingly the touch panel unit 23.

As shown in FIG. 13, the rotary shaft Ar of the motor 18a of the vibration mechanism 18 is provided along one short side 23j of the touch panel 23a. Accordingly, the direction of vibration generated by the vibration mechanism 18 is perpendicular to the short sides 23j, which means that the vibration mechanism 18 can vibrate the touch panel unit 23 in the X-direction. If the vibration mechanism 18 vibrates the touch panel unit 23 in Y-direction, the distance along the X axis (i.e., the moment arm) between each coupling portion 27a as a support of the touch panel unit 23 and the vibration mechanism 18 is large and the X-axial distances between the coupling portions 27a and the vibration mechanism 18 greatly vary, and hence the touch panel unit 23 is liable to swing over the XY plane. In this case, great variations in vibration may well occur in different positions on the touch panel 23a. In the second embodiment, however, the direction of vibration generated by the vibration mechanism 18 is set perpendicular to the short sides 23j, and hence the vibration mechanism 18 vibrates the touch panel unit 23 along the X-axis. Accordingly, the distance along the Y-axis (i.e., the moment arm) between each coupling portion 27a and the vibration mechanism 18 is small and the Y-axial distances between the coupling portions 27a and the vibration mechanism 18 do not greatly vary. Therefore, the touch panel unit 23 is prevented from swinging over the XY plane. Namely, the X-directional vibration of the touch panel 23a, which contains less swing components, can easily be obtained.

The eccentric weight 18b of the vibration mechanism 18 is located closer to the center of the short side 23j than the motor 18a. This means that the vibration point of the vibration mechanism 18 is located closer to the center of gravity of the touch panel unit 23, which more efficiently vibrates the touch panel unit 23. Further, the touch panel unit 23 is harder to swing over the XY plane than when the eccentric weight 18b of the vibration mechanism 18 is located remoter from the center of the short side 23j than the motor 18a. Namely, the X-directional vibration of the touch panel 23a, which contains less swing components, can easily be obtained.

Further, as described above, in the second embodiment, the battery pack 17 is located away from the hinge mechanism 13, while the vibration mechanism 18 is located close to the vibration mechanism 18. Thus, in this embodiment, the battery pack 17 and the vibration mechanism 18 are located efficiently so that they do not interfere with each other in the housing 22 of the first main unit 11.

Also, by locating the battery pack 17 away from the hinge mechanism 13, the relatively heavy battery pack 17 can be also used as the fall prevention means of the electronic device 10. For example, when the second main unit 12 is raised from the state shown in FIG. 9 to form an obtuse angle with respect to the first main unit 11 (XY plane) by forwardly rotating the second main unit 12 about the rotation axis Ax of the hinge mechanism 13, the battery pack 17, which is located away from the rotation axis Ax of the hinge mechanism 13, can prevent the second main unit 12 from falling.

Further, as shown in FIG. 13, push button mechanisms 30 as operation mechanisms are provided on the lower surfaces 23f of the short-side portions 23i of the frame 23c. In the second embodiment, the push button mechanisms 30 are provided at the respective lengthwise center portions of the short-side portions 23i, and the coupling portions 27a are provided at the opposite ends of each short-side portion 23i with the corresponding push button mechanism 30 interposed therebetween. The cover members 33 and coupling portions 27a (i.e., the swing support mechanisms 27) as moving parts of the push button mechanisms 30 are arranged symmetrical with respect to the above-mentioned center line C of the touch panel unit 23.

A printed circuit board 23m with electronic components for controlling the touch panel 23a is attached to the lower surface 23f of the long-side portion 23h of the frame 23c close to the hinge mechanism 13. The printed circuit board 23m is located near one (i.e., the left one in FIG. 13) of the short-side portions 23i opposite to the short-side portion 23i (i.e., the right one in FIG. 13) provided with the vibration mechanism 18.

As shown in FIGS. 9, 13, etc., the push button mechanisms 30 are provided on the respective short-side portions 23i. Each of the push button mechanisms 30 is interposed between the corresponding pair of the swing support mechanisms 27.

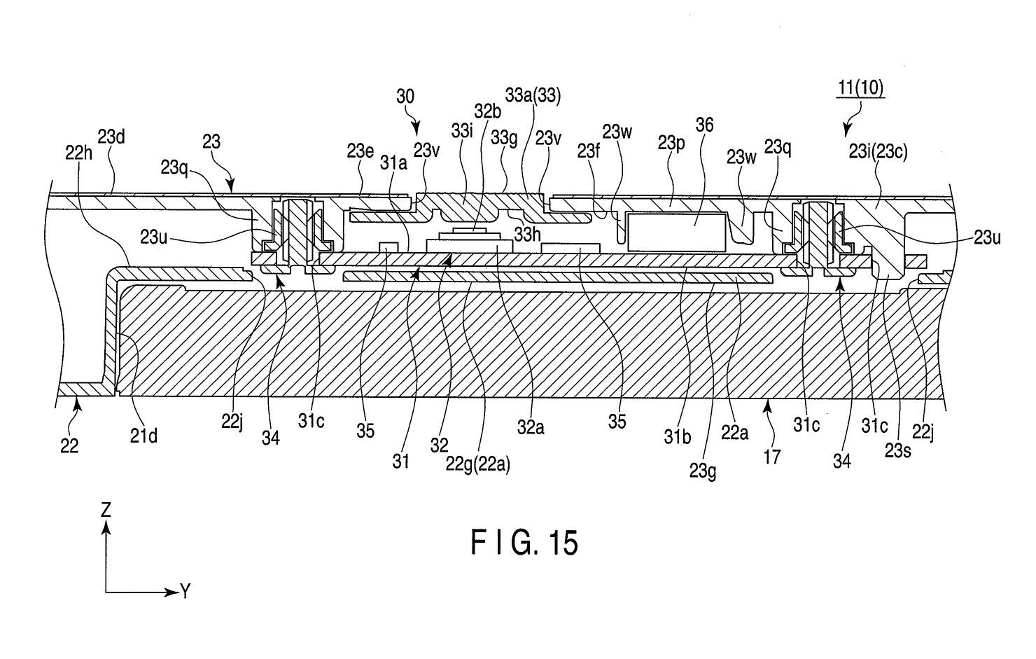

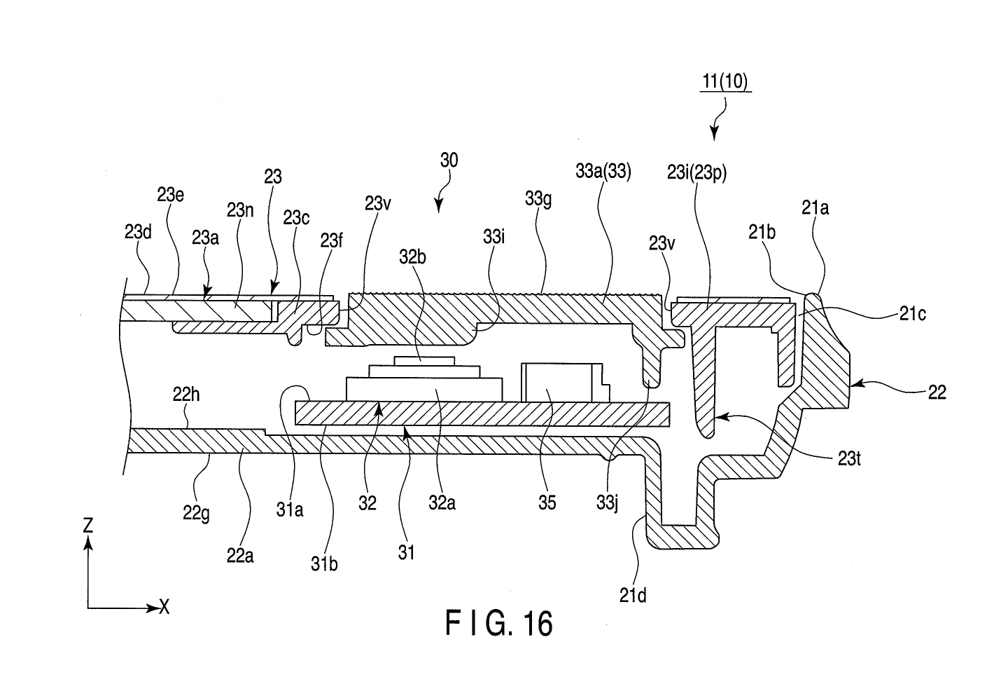

As shown in FIGS. 15, 16, etc., the push button mechanisms 30 each comprise a board 31 serving as an operation mechanism support member, a push button switch 32 attached to the board 31, and a cover member 33 covering the push button switch 32.

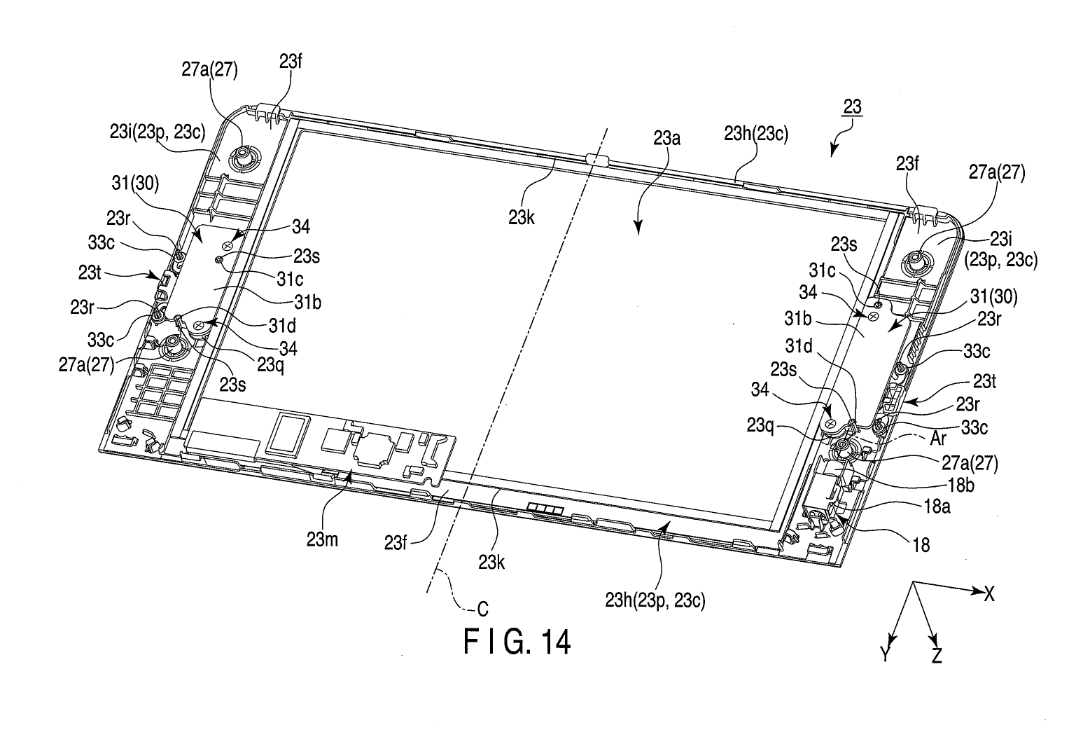

As shown in FIGS. 14 to 16, the boards 31 are located below and parallel to the wall 23p of the frame 23c, with gaps interposed therebetween.

As shown in FIGS. 13, 15, etc., the wall 23p of the frame 23c has downwardly projecting bosses 23q that serve as support member fixing portions. The bosses 23q are provided in several positions with gaps therebetween along the periphery 23n (see FIG. 16) of the touch panel 23a. (In the second embodiment, two bosses are provided for one push button mechanism 30.) The bosses 23q each have a cylindrical female screw member 23u fitted therein by, for example, insert molding. The female screw member 23u is engaged with a screw 34 inserted in a through hole 31c formed in each board 31, thereby fixing the bosses 23q to the boards 31 as shown in, for example, FIG. 6. The wall 23p has downward projections 23s. The projections 23s and the bosses 23q are coupled by means of, for example, ribs.

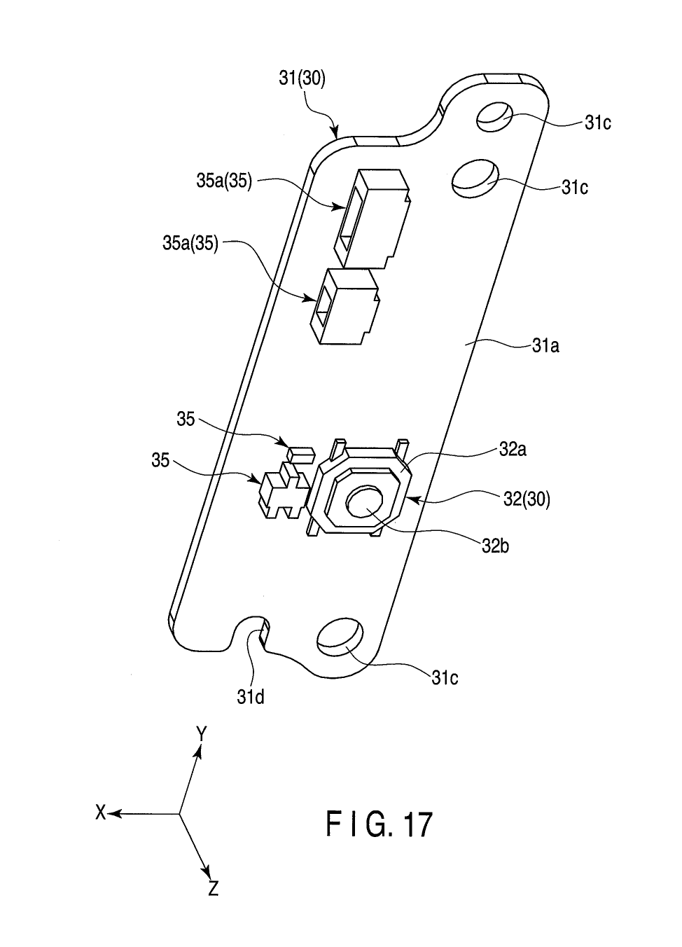

The boards 31 are each configured as a printed circuit board. As shown in FIG. 17, the upper surface 31a of each board 31 opposing the lower surface 23f of the wall 23p has the push button switch 32, component parts 35, etc., attached thereto by, for example, soldering. The push button switch 32 is connected to a control circuit (not shown) including, for example, a CPU via a patterned wire (not shown) formed on each board 31, a connector 35a as one of the component parts 35 mounted on each board 31, a harness (not shown) connected to the connector 35a, etc. Each board 31 has through holes 31c for inserting the corresponding projection 23s and screw 34, and a notch 31d. The through holes 31c for inserting the corresponding projection 23s and screw 34, and the notch 31d function as positioning means for said each board 31.

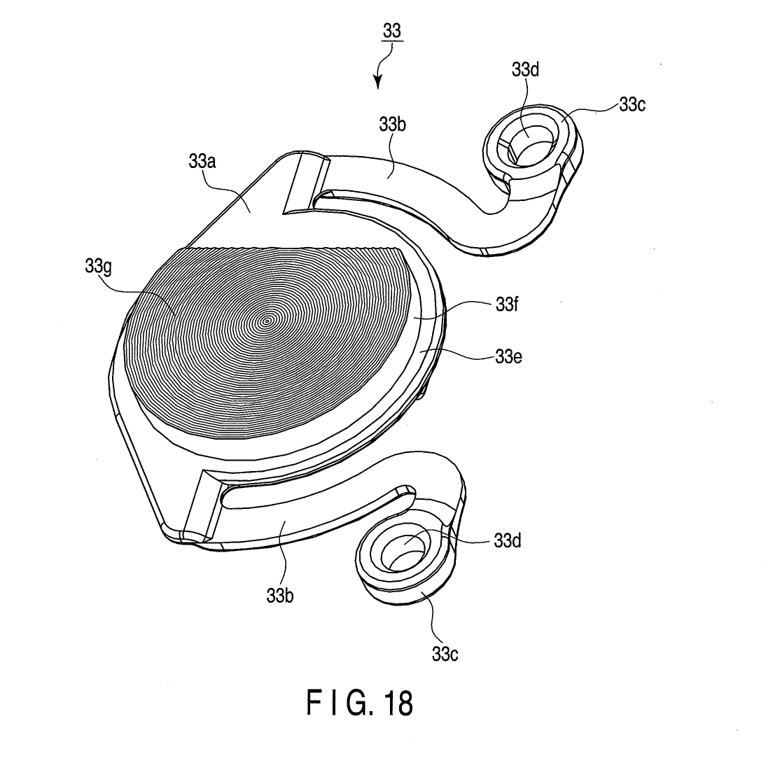

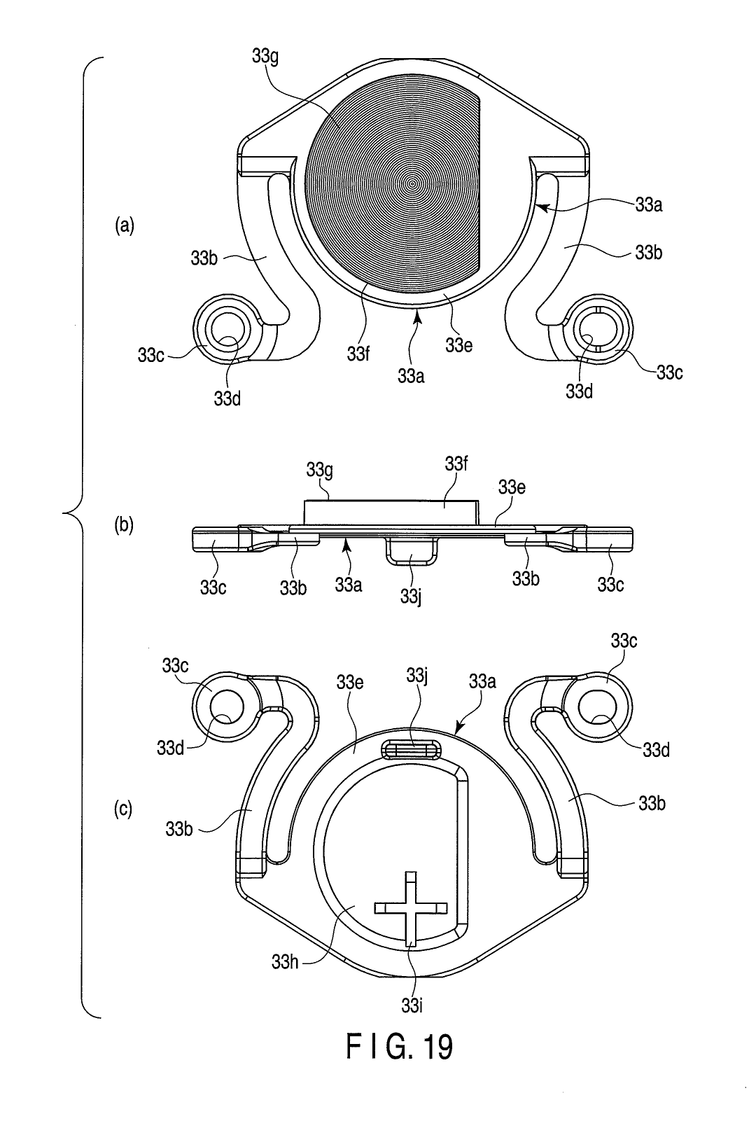

As shown in FIGS. 15 and 16, each cover member 33 covers the upper surfaces of the corresponding push button switches 32 with a gap defined therebetween. Each cover member 33 is formed of an elastic material containing elastomer, synthetic resin, etc. As shown in FIGS. 18 and 19, each cover member 33 comprises an operation portion 33a, arm portions 33b and fixing portions 33c. As shown in FIGS. 13 and 14, the lower surface 23f of the wall 23p has projections 23r serving as cover member fixing portions. In a state in which the projections 23r are inserted in the through holes 33d of the fixing portions 33c, the fixing portions 33c are adhered to the projections 23r and the lower surface 23f of the wall 23p, thereby fixing the cover member 33 to the frame 23c. In the second embodiment, each of the cover members 33 is fixed to the frame 23c by means of two fixing portions 33c. The two projections 23r corresponding to the two fixing portions 33c are provided with a gap therebetween along the Y-axis of the housing 22, as is shown in FIG. 13. Namely, in the second embodiment, each cover member 33 is supported at two points along the Y-axis, and at one point along the X-axis.

The operation portion 33a of each cover member is shaped like a disk. The arm portions 33b extending between the operation portion 33a and the fixed portions 33c each comprise a portion extending from the corresponding fixing portion 33c and an arcuate portion extending along the outer periphery of the corresponding operation portion 33a, these portions being coupled substantially in a V shape. By thus bending the arm portions 33b to increase their length, significant stress is prevented from occurring in the arm portions 33b. It is preferable that the arm portions 33b be formed so that the operation portions 33a will have sufficient rigidity to be kept stationary when no pressing force is exerted on but normal vibration and gravity are exerted on the operation portions 33a.

Each operation portion 33a comprises a ring-shaped thin base 33e, and a cylindrical projection 33f having substantially a D-shaped cross section and projecting from the central portion of the base 33e. A recess is formed in the backside (lower surface) 33h of the projection 33f. Further, a projection 33i opposing a movable portion 32b incorporated in the corresponding push button switch 32, and a projection 33j opposing the upper surface of the corresponding board 31, are provided on the backside 33h of the projection 33f. When each cover member 33 is assembled, the projection 33i opposes the upper surface of the movable portion 32b of the corresponding push button switch 32 with a gap therebetween, as is shown in FIGS. 15 and 16. When a user pushes down each cover member 33 using, for example, their finger, the projection 33i pushes down the movable portion 32b. Further, when the user pushes down the portion of each cover member 33 located away from the push button switch 32 (e.g., the right end of the operation portion 33a in FIG. 16), using, for example, their finger, the projection 33i is brought into contact with the upper surface 31a of the board 31 and serves as a support. Namely, in the embodiment, the projection 33i serves as an inclination suppressing portion. As shown in (c) of FIG. 19, the projection 33i is formed to have a cross-shaped section, which suppresses occurrence of dimple defects when the projection is formed.

As shown in FIGS. 15 and 16, the wall 23p has a through hole 23v. The projection 33f of the operation portion 33a of each cover member 33 is inserted through the through hole 23v and exposed at the upper surface 23e of the touch panel 23. In the second embodiment, the top 33g of each operation portion 33a is substantially level with the upper surface 23e of the touch panel 23. When each cover member 33 is pushed down by, for example, a user's finger, it is elastically deformed downwardly, whereby its operation portion 33a is pressed down from the upper surface 233. When the pressing force is released, the operation portion 33a is returned into the initial state.

Referring back to FIG. 13, a plurality of (two in the embodiment) bosses 23q are arranged on each short-side portion 23i along the Y-axis, with the corresponding cover member 33 held therebetween. This structure enables the short-side portions 23i to be more narrowed.

Further, in the second embodiment, the bosses 23q are arranged along one side of each short-side portion 23i, while the projections 23r are arranged along the other side of each short-side portion 23i. This enables efficient arrangement of the bosses 23q and the projections 23r on each short-side portion 23i, which enables downsizing of the short-side portions 23i and accordingly the touch panel unit 23.

Furthermore, in the second embodiment, the bosses 23q are arranged closer to the touch panel 23a than the projections 23r. This means that the boards 31 are attached to the proximal ends of the short-side portions 23i that are located closer to the touch panel 23a and have higher rigidity, and therefore that the boards 31 and the push button switches 32 can be more reliably supported by the short-side portions 23i.

In the second embodiment, as shown in FIGS. 13 and 14, a hooked projection 23t serving as a harness holding member is provided on the lower surface 23f of each short-side portion 23i between the corresponding projections 23r. This suppresses interference between the harnesses and the operation portions 33a and the arm portions 33b of the cover members 33.

As shown in FIG. 15, a magnet 36 is provided as a component attached to the lower surface 23f of the wall 23p, and has its lower portion covered with the board 31. The magnet 36 is a detection target detected by a hole element (not shown) as a magnetic sensor for detecting whether the first and second main units 11 and 12 are open or closed. The hole element is contained in the second main unit 12. The magnet 36 is attached to the lower surface 23f of the wall 23p by means of, for example, adhesion. This structure can suppress the board 31 moving the magnet 36 to another position in the housing 22. Further, a projection 23w for restricting the lateral movement of the magnet 36, and guiding the same when the magnet 36 is attached, is provided on the lower surface 23f of the wall 23p. The magnet 36 may be attached to the board 31.

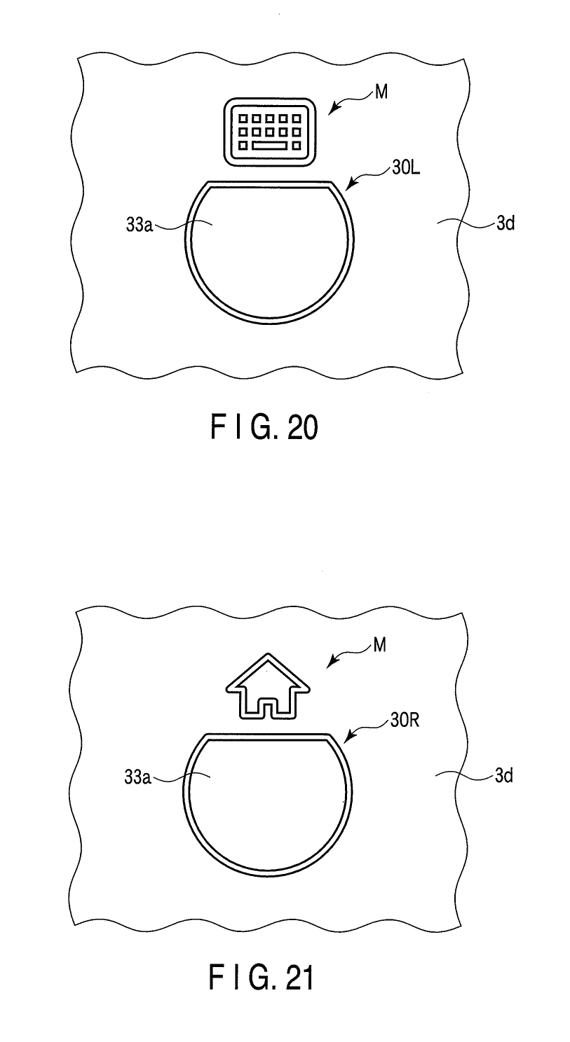

FIG. 20 is an enlarged view illustrating a part of the left push button mechanism 30 of the first main unit 11 shown in FIG. 9. FIG. 21 is an enlarged view illustrating a part of the right push button mechanism 30 of the first main unit 11 shown in FIG. 9. In the embodiment, the left push button mechanism 30 shown in FIG. 20 is assigned as an operation button 30L for keyboard display, described later, and the right push button mechanism 30 shown in FIG. 21 is assigned as an operation button 30R for returning to the application lastly activated in the electronic device 10.

For instance, the operation button 30L for keyboard display includes the upper portion of the left operation portion 33a exposed at the upper surface 21a of the housing 22 of the first main unit 11. As shown, the exposed upper portion of the left operation portion 33a is not shaped circular, but has a D-shaped cross section obtained by linearly cutting part thereof close to the hinge mechanism 13. Further, a mark M for indicating the type of the operation button 30L is drawn close to the linear line of the upper portion of the left operation portion 33a on the portion of the cover 23d that covers the left portion of the upper surface of the housing 22. The mark M is a simplified figure having, for example, black and white portions.

By thus drawing the “keyboard” mark M adjacent to the operation button 30L, the user can easily recognize the role of the operation button 30L. Thus, the mark M enhances operability and convenience of the device. In particular, the design of the left operation portion 33a of the D-shaped cross section, and the mark M provided along the linear line of the upper portion of the left operation portion 33a enhances the appearance of the entire operation button.

Similarly, as shown in FIG. 21, the right operation button 30R indicating “home” includes the upper portion of the right operation portion 33a exposed at the upper surface 21a of the housing 22 of the first main unit 11. As shown, the exposed upper portion of the right operation portion 33a is not shaped circular, but has a D-shaped cross section obtained by linearly cutting part thereof close to the hinge mechanism 13. Further, a mark M of “house” is drawn for indicating “home.”

Further, as mentioned above, the two operation buttons 30R and 30L are provided on the right and left portions of the first main unit 11 symmetrically with respect to the center line C shown in FIG. 13, which provides a balanced good appearance. In particular, since the exposed upper portions of the right and left operation portions 33a are not shaped circular, but have D-shaped cross sections obtained by linearly cutting part thereof close to the hinge mechanism 13, and since the marks M are drawn close to the right and left operation buttons 30R and 30L, the user can easily recognize the orientations of the operation buttons. In other words, the linear lines of the operation buttons can be used as clues to the recognition of the orientation of the electronic device 10. Since, in particular, the electronic device 10 of the embodiment can be used in a dual mode in which both the first and second main units 11 and 12 display images, it is important to facilitate the recognition of orientation in enhancing the convenience of the device.

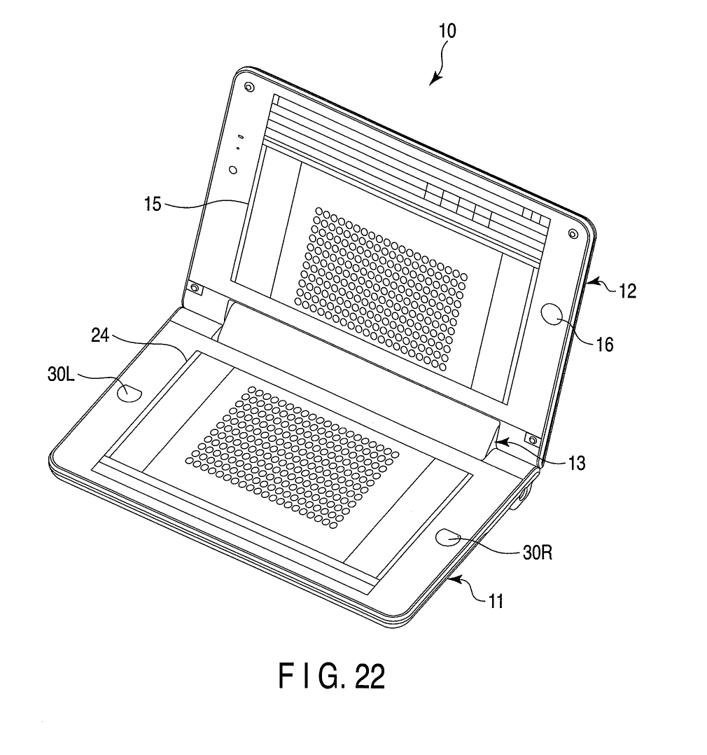

FIG. 22 shows an example of a dual-mode screen that displays one image on the display panels 24 and 15 of the first and second main units 11 and 12. In this example, the first main unit 11 is placed on a horizontal plane, such as a disk, and the second main unit 12 is raised toward the user by upwardly rotating the same about the hinge mechanism 13. Namely, FIG. 22 shows a state in which the two display panels 15 and 24 are arranged one above the other. As another way of use of the dual mode, the display panels 24 and 14 of the first and second main units 11 and 12 may be arranged side by side. More specifically, the first main unit 11 is grasped by the left hand, and the second main unit 11 is grasped by the right hand.

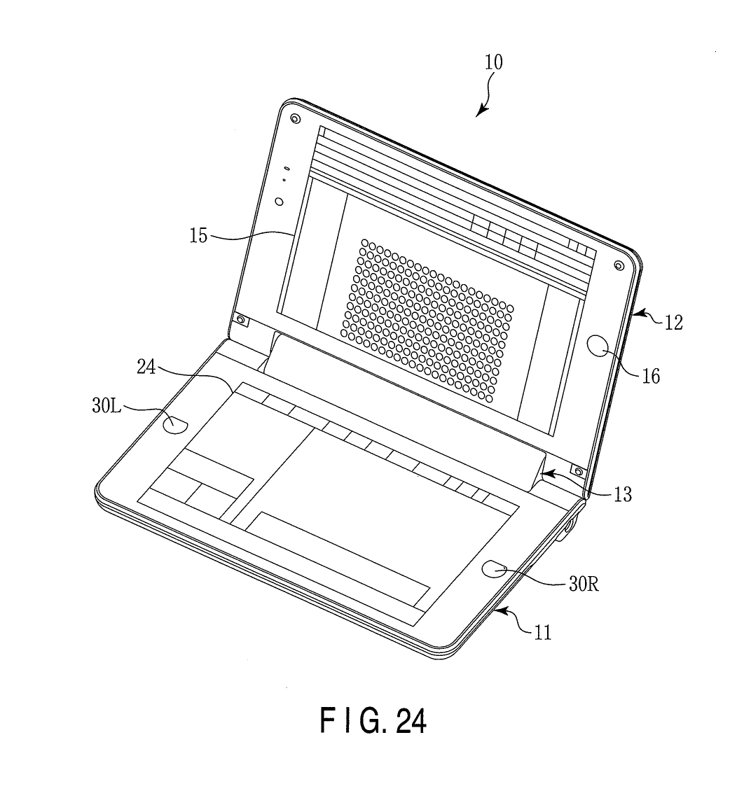

When the user clicks, using a left finger, the operation button 30L for keyboard display in the state shown in FIG. 22, the image displayed on the display panel 24 of the first main unit 11 is switched to such an image of a keyboard as shown in FIG. 24. In contrast, when the user again clicks the operation button 30L, the image on the display panel 24 is returned to the dual mode image shown in FIG. 22.

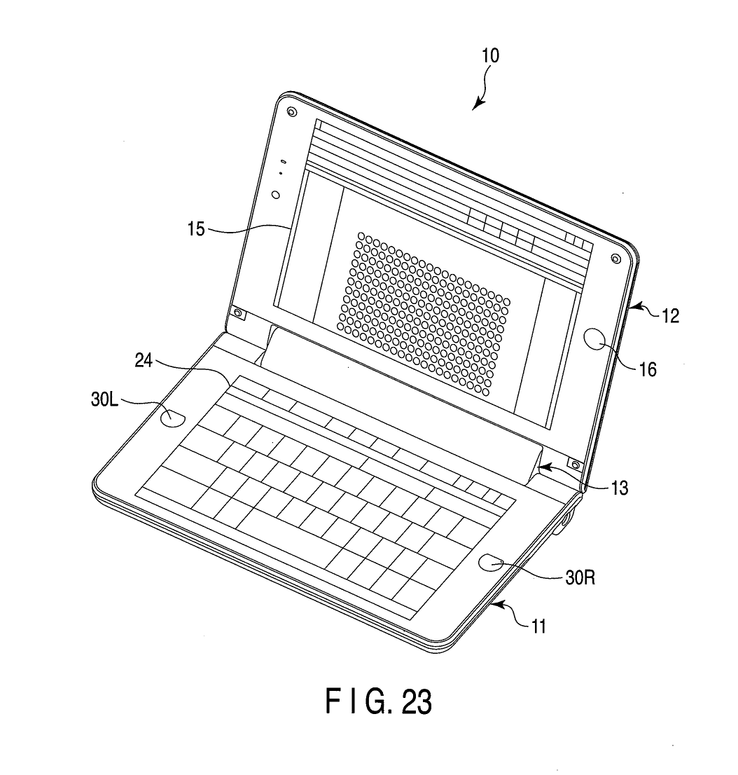

Further, when the keyboard image is displayed on the display panel 24 as shown in FIG. 23, if the user touches a button image in the keyboard image, a key input operation is executed. Namely, in this state, the electronic device 10 functions as a so-called note PC. It is a matter of course that the key input operation enables, for example, editing of, for example, character images displayed on the display panel 15 of the second main unit 12.

Furthermore, when the user double-clicks the operation button 30L in the dual mode shown in FIG. 22, the image on the display panel 24 of the first main unit 11 is switched to the mouse pad image shown in FIG. 24. Similarly, when the user double-clicks the operation button 30L in the mode shown in FIG. 24, the mode is returned to the dual mode of FIG. 22.

As described above, since the operation button 30L for displaying a keyboard image or a mouse pad image is located in the left position corresponding to the left hand of the user, the user can start a keyboard input operation (or a mouse pad operation) immediately after pressing the operation button 30L. Namely, since the dominant hands of most people are right hands, the operation button 30L in the left position is advantageous in enhancing the operability of the device.

When the electronic device is used with the two screens arranged side by side, i.e., when the portion of the first main unit 11 indicated by the broken line L is held by the left hand, and the portion of the second main unit 12 indicated by the broken line R is held by the right hand, the operation button 30L for keyboard display is positioned in the upper left position. However, when the electronic device is used with the two screens positioned side by side, the possibility of the use of the keyboard is extremely weak. Because of this, it is advantageous to locate the operation button 30L as shown in the figures in light of the fact that this location is convenient when the two screens are arranged one above the other as shown in FIGS. 22 to 24.

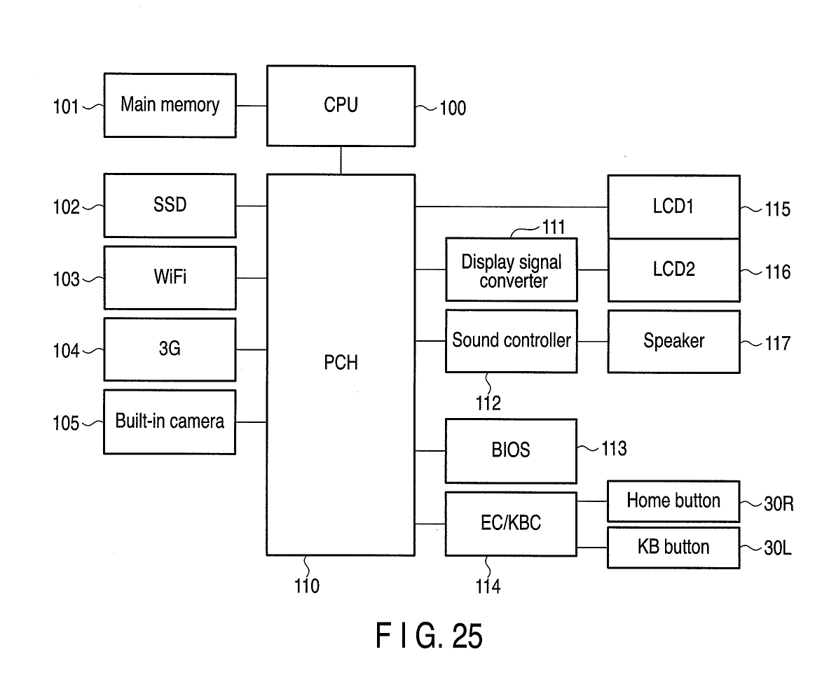

Referring now to the block diagram of FIG. 25, a description will be given of a system structure for displaying the above-described “keyboard” and “mouth pad.”

Assume here that both LCDs 115 and 116 are realized as touch screen displays.

This system comprises a CPU 100, a main memory 101, an SSD (Flash Solid State Drive, Flash Solid State Disk) 102, a WiFi 103, a 3G 104, a built-in camera 105, a PCH (Platform Controller Hub) 110, a display signal converter 111, a sound controller 112, a BIOS-ROM 113, an EC/KBC 118, a home button 30R, a keyboard button 30L, a speaker 117, etc.

The CPU 100 is a processor for controlling the operation of the computer 10, and is configured to execute an operating system (OS), various application programs, etc., loaded from a storage medium, such as the SSD 102, to the main memory 10. The application programs include, for example, an input control program. The input control program emulates the operations of the keyboard and the touch pad, using the touch position detecting function of each touch screen display (touch panel). The CPU 100 also executes a system BIOS (Basic Input Output System). The system BIOS is a program for hardware control. The CPU 100 executes processing for drawing display images of the “keyboard” and “mouth pad.” The PCH 110 controls devices associated with signal input and output, such as a serial ATA, a USB and a LAN. The display signal converter 111 converts SVDO (Serial Digital Video Output) signals output from the PCH 110, into LVDS (Low Voltage Differential Signaling) signals. The sound controller 112 controls the speaker 117.

The EC/KBC 118 has a function of turning on/off the computer 10 in accordance with user's keyboard operation or power button switch operation.

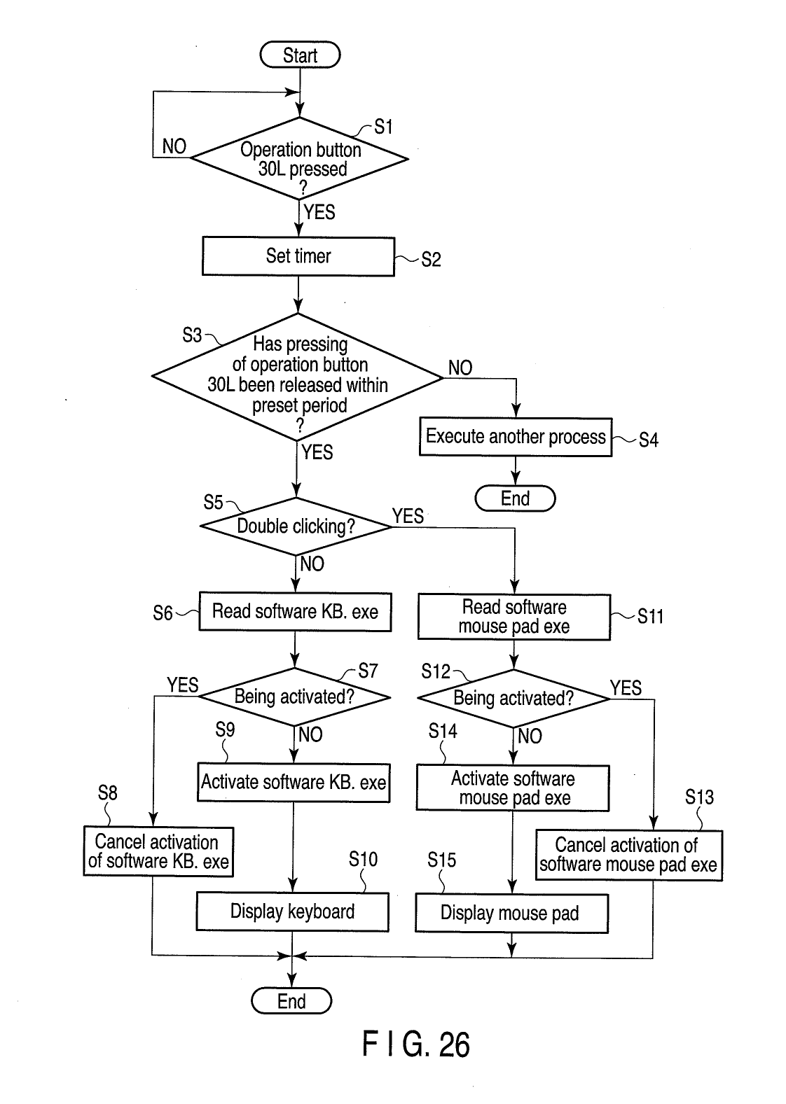

Referring then to the flowchart of FIG. 26, a description will be given of the operation, by the above-mentioned controller, of displaying the “keyboard” and “mouth pad.”

For instance, when the operation button 30L is pressed, with the dual mode screen images displayed on the two display panels 24 and 15 as shown in FIG. 22 (Yes at step S1), the CPU 100 sets a timer (step S2) to measure the time for which the operation button 30L is pressed. Namely, at this step, it is determined whether the operation button 30L has been pressed for a relatively long time.

If it is determined that the operation button 30L has been pressed for a relatively long time (No at step S3), the CPU 100 executes other processing such as calling the Internet explorer (step S4).

In contrast, if it is determined that the operation button 30L has been pressed once for only a short time (Yes at step S3), the CPU 100 again sets the timer to thereby determine whether the operation button 30L has been again pressed (i.e., double clicking has been made) (step S5).

If it is determined that there was no double clicking (No at step S5), the CPU 100 reads software KB.exe for displaying the keyboard (step S6). If the software KB.exe is already activated (Yes at step S7), the CPU 100 cancels the activation of the read software KB.exe (step S8).

If it is determined that the software KB.exe is not activated (No at step S7), the CPU 100 activates the read software KB.exe (step S9), and displays the keyboard on the display panel 24 as shown in FIG. 23.

In contrast, if double clicking is detected at step S5 (Yes at step S5), the CPU 100 reads software mouse pad exe for displaying the mouse pad (step S11). If the mouse pad exe is already executed (Yes at step S12), the CPU 100 cancels the activation of the read mouse pad exe (step S14), and displays the mouse pad on the display panel 24 as shown in FIG. 24 (step S15).

As shown in FIG. 27, the electronic device 10 of the second embodiment has the swing support mechanisms 27 that are similar to the swing support mechanisms 7 of the first embodiment. Namely, each swing support mechanism 27 comprises the support bracket 22c provided on the housing 22, an elastic bush 28 attached to the support bracket 22c, a coupling portion 27a inserted through a through hole 28a formed in the elastic bush 28, and a screw 29 as an engagement member to be engaged with the coupling portion 27a.

The support bracket 22c is provided on a peripheral portion of the bottom 22a of the housing 22, serving as a cylindrical boss projecting to the wall 23p as a to-be-supported portion. A circular through hole 22e is formed in the center portion of the top wall 22d of the support bracket 22c, and an inwardly extending flange 22f is formed around the through hole 22e.

The elastic bush 28 is formed cylindrical and made of an elastic material such as an elastomer (e.g., a synthetic resin), and has an annular groove 28c formed in the axial center portion of the periphery 28b of the bush 28. The elastic bush 28 is attached to the bracket 22c by engaging the annular groove 28c of the bush 28 with the flange 22f of the bracket 22c.

Since the elastic bush 28 is elastically deformable, it can be easily inserted into the through hole 22e from above. Thus, the elastic bush 28 can be relatively easily attached to the support bracket 22c. The elastic bush 28 is formed asymmetrical at axially opposite ends, which suppresses erroneous attachment of the elastic bush 28 to the support bracket 22c. Further, as shown in FIG. 27, the elastic bush 28 of the second embodiment has slopes 28d and 28e, as in the first embodiment. The elastic bush 28 also has an upper expanded portion 28f held between the frame 23c and the flange 22f, and a lower expanded portion 28g held between the head 29a of the screw 29 and the flange 22f, as in the first embodiment.

The coupling portion 27a is formed as a cylindrical boss projecting downwardly from the frame 23c. As shown in FIG. 27, in a state in which the device is assembled, the coupling portion 27a projects through the through hole 22e of the support bracket 22c to the backside of the support bracket 22c. The coupling portion 27a has a female screw hole 27b as a female screw portion opening downward.

The screw 29 includes a head portion 29a, and a male screw portion 29b screwed into the female hole 27b. The screw 29 is screwed into the female screw hole until the head portion 29a contacts the end face 27c of the coupling portion 27a.

The swing support mechanism 27 shown in FIG. 27 is formed by fitting the elastic bushes 28 into the support brackets 22c from above, then bringing the touch panel unit 23 close to the housing 22 from above to thereby insert the coupling portions 27a into the through holes 28a of the elastic bushes 28, and fastening the screws 29 into the female screw holes 27b of the coupling portions 27a from the backside. Since the elastic bushes 28 are thus fitted into the bracket portions 22c, the assembling work can be more easily and smoothly carried out than in the case of adhering or screwing elastic members.

In the second embodiment, the coupling portions 27a are inserted through the through holes 28a of the elastic bushes 28 along the width of the display panel 24, as in the first embodiment. Further, in a state in which the swing support mechanisms 27 are assembled, the upper expanded portions 28f of the elastic bushes 28 are interposed between the support brackets 22c as part of the housing 22 and the frame 23c of the touch panel unit 23, and the lower expanded portions 28g of the elastic bushes 28 are interposed between the support brackets 22c and the screws 29. Further, the elastic bushes 28 surround the coupling portions 27a. The support brackets 22c are formed as bosses upwardly projecting from the bottom 22a of the housing (namely, projecting toward the wall 23p of the frame 23c).

Also in the second embodiment, an annular projection 28h is provided on the inner surface of the through hole 28a of each elastic bush 28, and a plurality of projections 23g are circumferentially provided on the lower surfaces 23f of the frame 23c opposing the elastic bushes 28. These projections 28h and 23g serve as a structure for reducing the contact area between each elastic bush 28 and the touch panel unit 23 assumed when the device is assembled. These arrangements are just examples. Alternatively, for instance, projections may be provided on the coupling portions 27a, or on the upper surfaces of the elastic bushes 28. Further, a single annular projection may be provided, or a plurality of projections be provided circumferentially.

Further, in the second embodiment, as shown in FIG. 12, the screws 29 incorporated in the swing support mechanisms 27, and the screws 34 incorporated in the push button mechanisms 30, and the projections 23r are exposed at the lower surface 22g of the bottom 22a. Namely, before the screws 29 and 34 are fastened, the end faces 27c (see FIG. 27) of the coupling portions 27a providing the swing support mechanisms 27 are exposed at the lower surface 22g of the bottom 22a, and the bosses 23q and the projections 23r are exposed at the lower surface 22g through the through holes 22j formed in the bottom 22a. Accordingly, when the screws 29 and 34 are fastened with the battery pack 17 detached from the recess 21d, the swing support mechanisms 27 and the push button mechanisms 30 can be more easily and smoothly assembled, and hence the touch panel unit 23 can be more easily attached to the housing 22. Further, since the screws 29 and 34 can be fastened simultaneously, the assemblage efficiency can be more enhanced. Furthermore, since the battery pack 17 lastly covers the screws 29 and 34, these screws are prevented from being erroneously detached to thereby prevent unintentional detachment of the touch panel unit 23 and the push button mechanisms 30 from the housing 22. As a result, a simpler structure can be realized than in the case where a cover dedicated to the screws 29 and 34 is employed. Alternatively, a seal 22i as an example of the cover may be provided to cover the screws 29 and 34, as is shown in FIG. 27. The second embodiment is also advantageous in that the housing 22 can be made thin since the battery pack 17 itself is used as a lid for the recess 21d. The user can confirm the attachment state of the board 31 by exposing the positioning projections 23r through the through holes 22j.

Thus, the electronic device 10 of the second embodiment has the same swing support mechanisms 27 as the swing support mechanisms 7 of the first embodiment although they differ in specifications such as size, number and position. Namely, the electronic device 10 of the second embodiment having the swing support mechanisms 27 can provide the same advantage as the television receiver 1 of the first embodiment having the swing support mechanisms 7. The swing support mechanisms 27 of the second embodiment function as suppression sections for the elastic bushes 28, like the swing support mechanisms 7 of the first embodiment.

Further, as described above, the electronic device 10 of the second embodiment the push button mechanisms 30 similar to those of the first embodiment and functioning as operation mechanisms. Accordingly, the second embodiment can provide the same advantage as that obtained by the corresponding mechanisms of the first embodiment.

In particular, in the second embodiment, in a dual mode state in which two screens are arranged one above the other as shown in FIG. 22, the keyboard can be displayed on the display panel 24 of the first main unit 11 simply by clicking the operation button 30L positioned on the left portion of the first main unit 11. This enables the electronic device 10 to be instantly switched, for example, from the dual mode state shown in FIG. 22 to the keyboard input enabled state shown in FIG. 23, thereby enhancing the convenience of the device 10.

Moreover, the electronic device 10 of the second embodiment can be also used in a state (in which the two screens are arranged side by side) assumed by clockwise rotating the device through 90° from the state of FIG. 9 in which the first and second main units 11 and 12 are open. In this case, the electronic device 10 can be functioned as, for example, an electronic book. Further, in this case, the user holds the long-side portion 23h of the first main unit 11 by the left hand, and holds the long-side portion of the second main unit 12 by the right hand.

In this state, the operation button 30R for “home” incorporated in the first main unit 11 is positioned lower left to the user, and the power button 16 incorporated in the second main unit 12 is positioned lower right to the user. Namely, where the two screens are arranged side by side, the user can easily operate the operation button R by the left hand, and the power button 16 by the right hand. In this state, the operation button 30L for keyboard display is positioned upper left to the user. This involves no problem since the possibility of using the keyboard is weak when the user uses the electronic device 10 as an electronic book.

Further, in the second embodiment, the bosses 23q are arranged along one side of each short-side portion 23i, while the projections 23r are arranged along the other side of each short-side portion 23i. This enables efficient arrangement of the bosses 23q and the projections 23r on each short-side portion 23i, which enables downsizing of the short-side portions 23i and accordingly the touch panel unit 23. Furthermore, in the second embodiment, the bosses 23q are arranged closer to the touch panel 23a than the projections 23r, whereby the boards 31 can be more reliably supported. In addition, the second embodiment incorporates the magnet 36 as a component attached to the lower surface 23f of the wall 23p, and the board 31 covers the rear side of the magnet 36. Thus, the board 31 can be used as a cover for the magnet 36 as a component.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Although the above-described embodiments are directed to the television receiver or the note PC having two display screens, the invention is not limited to them. The invention is also applicable to other types of electronic devices having a display panel and a front panel opposite thereto, such as a PC having one display screen (a note PC or a desk top PC), a personal digital assistant (PDA), a smart book, a smart phone, and a portable phone terminal. The invention is further applicable to devices incorporating, for example, an ARM processor that does not have a PC architecture.

What is claimed is:

1. A broadcast receiving device comprising:
a first casing comprising a first screen with a first touch panel;
a second casing comprising a second screen with a second touch panel;
a hinge coupling the first and second casings and configured to allow the first and second casings to rotate between a closed position where the first and second screens are facing each other, and an open position where the first and second casings are not facing each other;
two operation buttons on the first casing and symmetrical with each other with respect to a center line through respective centers of the first and second casings; and
a power button on the second casing and configured to face to one of the two operation buttons when the first and second screens are in the closed position,
wherein the first screen is configured to display a keyboard image for an input operation through the first touch panel, when one of the two operation buttons is operated.

2. An electronic device comprising:
a first casing comprising a first screen with a first touch panel;
a second casing comprising a second screen with a second touch panel;
a hinge coupling the first and second casings and configured to allow the first and second casing to rotate between a closed position where the first and second screens are facing each other, and an open position where the first and second casings are not facing each other;
two operation buttons on the first casing and symmetrical with each other with respect to a center line passing through respective centers of the first and second casings; and
a power button on the second casing and configured to face to one of the two operation buttons when the first and second screens are in the closed position,
wherein the first screen is configured to display a keyboard image for an input operation through the first touch panel, when one of the two operation buttons is operated.

3. The electronic device of claim 2, wherein the one of the two operation buttons is positioned on an opposite side of a dominant hand of a user when the user faces the first screen.

4. An electronic device comprising:
a first casing comprising a first screen with a touch panel provided on the first casing;
a second casing comprising a second screen; and
an operation button,
wherein the first screen is configured to display a keyboard image for an input operation through the touch panel when the operation button is operated.

5. The electronic device of claim 4, further comprising a hinge coupling a first end of the first casing to a first end of the second casing, and configured to allow the first and second casings to rotate with respect to each other in such a manner that a distance between the second end of the first casing and the second end of the second casing changes.

6. The electronic device of claim 5, wherein the operation button is positioned on an opposite side of a dominant hand of a user with respect to the first screen when the first casing is positioned close to the user and the second casing is positioned away from the user.

7. The electronic device of claim 6, further comprising a second operation button positioned close to the dominant hand of the user with respect to the first screen.
